(19) United States
(12) Patent Application Publication
(10) Pub. No.: US 2012/0153181 A1
(43) Pub. Date: Jun. 21, 2012

(54) RADIATION IMAGE CAPTURING APPARATUS AND RADIATION IMAGE OBTAINING METHOD

(75) Inventors: Naoto IWAKIRI, Ashigarakami-gun (JP); Dai MURAKOSHI, Ashigarakami-gun (JP)

(73) Assignee: FUJIFILM CORPORATION, Tokyo (JP)

(21) Appl. No.: 13/331,618

(22) Filed: Dec. 20, 2011

(30) Foreign Application Priority Data
Dec. 20, 2010 (JP) 2010-283383
Dec. 19, 2011 (JP) 2011-277011

(51) Int. Cl. G01T 1/16

(52) U.S. Cl. 250/394; 250/395

(57) ABSTRACT

A radiation image capturing apparatus includes: a first grid which includes grid structures disposed at intervals and forms a first periodic pattern image by passing radiation emitted from a radiation source; a second grid provided with grid structures disposed at intervals and forms a second periodic pattern image by receiving the first periodic pattern image; a radiation image detector that detects the second periodic pattern image formed by the second grid; and a detector positioning mechanism that adjusts a position of the radiation image detector in an in-plane direction of a detection plane of the detector such that radiation transmitted through the first and second grids falls within the radiation image detector.

### BACKGROUND OF THE INVENTION

1. Field of the Invention

The present invention relates to a radiation image obtaining method and a radiation image capturing apparatus using a grid.

2. Description of the Related Art

X-rays are used as a probe for looking through the inside of a subject as they attenuate, when passing through a substance, according to the atomic number of the element constituting the substance, as well as the density and thickness of the substance. X-ray imaging is widely used in the fields of medical diagnosis, nondestructive inspection, and the like.

In a general X-ray imaging system, a transmission image of a subject is captured by placing the subject between an X-ray source that emits X-rays and an X-ray image detector that detects X-ray images. In this case, each X-ray emitted from the X-ray source toward the X-ray image detector is incident on the X-ray detector after being attenuated (absorbed) by an amount corresponding to a difference in properties (atomic number, density, thickness) of the substance constituting the subject located in the transmission path from the X-ray source to the X-ray image detector. As a result, an X-ray transmission image of the subject is detected by the X-ray image detector and a radiation image is produced. As for the X-ray image detector, flat panel detectors using a semiconductor circuit are widely used, in addition to combinations of X-ray intensifying screens with films and photostimulable phosphors.

However, the X-ray absorption power is low for a substance constituted by an element with a small atomic number in comparison with a substance constituted by an element with a high atomic number. As such, the difference in X-ray absorption power is small in soft biological tissues and soft materials, thereby causing a problem of insufficient contrast as an X-ray transmission image. For example, the articular cartilage and synovial fluid constituting a joint of a human body consist mostly of water and the difference in the amount of X-ray absorption between them is small, thereby resulting in a low image contrast.

Recently, research has been conducted on X-ray phase contrast imaging for obtaining a phase contrast image based on X-ray phase shift resulting from the difference in refractive index of subject instead of X-ray intensity change resulting from the difference in absorption coefficient of subject. The X-ray phase contrast imaging using the phase difference of the X-ray wave-front may obtain a high contrast image even for a weak absorption object having a low X-ray absorption capability.

The X-ray phase contrast imaging is a new imaging method that utilizes X-ray phase/refraction information, and is capable of imaging a soft tissue which is difficult to be imaged by the conventional imaging method based on X-ray absorption due to a small absorption difference that produces almost no image contrast.

Heretofore, such soft-tissue portions may have been imaged by MRI, but the MRI imaging has problems of a long imaging time of several tens of minutes, a low image resolution of about 1 mm, and a low cost-effectiveness that makes it difficult to perform MRI imaging at regular physical examinations such as health checkups.

X-ray phase contrast imaging may also have been possible by monochromatic X-rays with well-aligned phase generated from a large scale radiation facility (e.g., SPring-8, Hyogo, JAPAN) or the like, but such a radiation facility is too large to be available in a general hospital.

Further, the X-ray phase contrast imaging may image cartilages and soft-tissue portions which is difficult to be observed in X-ray absorption contrast images as described above. Thus, a wide variety of the diseases, which include joint disease, such as knee osteoarthritis, rheumatoid arthritis, sports disorders, meniscus injuries, tendon injuries, and ligament injuries, and other abnormality such as a tumor for breast cancer and the like, may be diagnosed quickly and easily with the X-ray phase contrast images. As such, the X-ray phase contrast imaging is a method that may contribute to early diagnosis, early treatment, and reduction of medical spending in an aging society.

As the X-ray phase contrast imaging described above, for example, an X-ray phase contrast image capturing system is proposed in which first and second grids are disposed in parallel at a given distance to form a self-image of the first grid at the position of the second grid by the Talbot interference effect and an X-ray phase contrast image is obtained from a plurality of images generated by intensity-modulating the self-image by the second grid.

Here, the refraction angle of an X-ray due to phase shift of the X-ray that may occur by interacting with a subject is several micro-radians at the highest for soft tissue. It is necessary to measure the positional displacement amount of the X-ray, which is typically only several micrometers, caused by the refraction to obtain a sufficient image contrast to identify such a tissue. But, the pixel pitch of the radiation image detector is typically several tens to hundreds of micrometers, which makes it difficult to directly measure the positional displacement. Consequently, the X-ray phase contrast image capturing system described above is configured to perform an image capturing operation every time one of the two grids is moved relative to the other grid in the arrangement direction thereof to measure a change in moiré fringes generated by the two grids. That is, phase shift amounts in moiré fringes are analyzed using a so-called fringe scanning method to measure the fractional refraction angle described above. The phase shift amounts in moiré fringes are also very small so that a small change in the moiré images will greatly influence the accuracy of phase retrieval.

In the mean time, various types of radiation image capturing cassettes, constituted by a radiation image detector or the like accommodated in a housing, are proposed. The radiation image capturing cassettes are easy to handle as they are thin and of a portable size. Further, they come in various sizes and shapes appropriate for the size or type of each subject and are configured to be removably attachable to an image capturing system according to a condition of a subject. Thus, it would be advantageous to employ such a cassette in the X-ray phase contrast image capturing system described above.

For the first and second grids of the X-ray phase contrast image capturing system, various sizes and shapes according to the subject size and the like are available. As such, it may also be considered to configure the first and second grids to be removably attachable to the system, as in the radiation image detector, for replacing them according to the intended use. Once the first and second grids are made to be removably attachable, it is possible to configure an image capturing system capable of capturing both X-ray phase contrast images and ordinary X-ray absorption contrast images.

Here, unless the first and second grids are disposed such that radiation emitted from the radiation source is substantially perpendicularly incident thereon, the radiation will be obliquely incident on the grids, and the oblique incident causes the radiation to be shaded by the wall of the grids. Such vignetting of radiation causes the intensity of the radiation transmitting through the grids to be decreased in comparison with the intensity in the case where the radiation is perpendicularly incident on the grids.

In the X-ray phase contrast image capturing system described above, a phase contrast image is reconstructed by measuring a phase shift of the X-ray wave-front when transmitting through a subject, i.e., by measuring changes in the intensity of moiré fringes generated by the two grids. But when the intensity of the radiation is decreased after transmitting through the grids, the signal to noise ratio (S/N ratio) of the moiré fringe images is degraded, thereby causing calculation errors which may lead to significant degradation in the contrast and resolution of the phase contrast image.

The impact of the radiation intensity reduction due to the vignetting of radiation on the phase contrast image is far greater when compared to an ordinary X-ray still or motion image which is not an image reconstructed by calculation based on a fractional intensity change in a plurality of images. Further, the impact is also great when compared to CT (Computed Tomography), tomosynthesis, or the like that reconstructs an image after capturing a plurality of images by changing the incident angle of the X-ray on the subject, or the energy subtraction that reconstructs an image after capturing a plurality of images by changing the energy of the X-ray to the subject.

In capturing the phase contrast image described above, a fractional X-ray positional displacement of several micrometers on the radiation image detector due to a phase shift of the X-ray wave-front that occurs in the subject is measured from moiré images, but the image of the subject itself does not almost change. On the other hand, in CT or tomosynthesis imaging in which images are captured by changing the incident angle of the X-ray, the images of the subject change greatly. In comparison with other radiation imaging in which a reconstruction image is calculated from a plurality of such images, the impact of a fractional image change on the phase contrast image is great. Also in energy subtraction imaging in which subject images are captured by X-rays having a plurality of different energies with the same incident angle and a distribution of the energy absorption is reconstructed to separate soft tissues from bone tissues, the contrast of the subject changes greatly among a plurality of images due to difference in the imaging energy. Thus, in comparison with the energy subtraction image, the impact of a fractional image change on the phase contrast image is great.

Due to the reasons described above, the first and second grids are preferred to be disposed such that the radiation emitted from the radiation source is incident thereon substantially perpendicularly. In the case where the aforementioned radiation imaging cassettes of different sizes are used in conjunction with the first and second grids disposed in the manner as described above, radiation transmitted through the first and second grids may be extended beyond the detector or concentrated in the corner depending on the size thereof as the sizes of the grids are small relative to the sizes of the radiation image detectors, thereby causing a problem of inappropriate phase contrast image.

The same problem may occur when the two diffraction grids and radiation source are moved according to the position of the subject, not just when the radiation image detector is replaced with another having different size.

Japanese Unexamined Patent Publication No. 2004-147917 describes that the radiation image detector is moved according to the movement of the radiation source, but does not consider at all the problem of vignetting of radiation by the first and second grids, use of cassettes of different sizes, and the problem that there may be a case in which radiation transmitted through the grids is extended beyond the detector.

In a system in which imaging is performed by switching three methods of Talbot interferometry, Talbot-Lau interferometry, and refraction contrast, WO 2008-102598 proposes to switch between the refraction contrast method that does not use the two grids and Talbot interferometry method that uses the grids by configuring the grids to be removably attachable. But WO 2008-102598 does not consider the problem at all, when two diffraction grids are used, that radiation transmitted through the grids may be extended beyond the radiation image detector.

In view of the circumstances described above, it is an object of the present invention to provide a radiation image pickup method and radiation image capturing apparatus capable of minimizing the vignetting of radiation incident on first and second grids and obtaining a more satisfactory phase contrast image by detecting radiation transmitted through the first and second grids by a radiation image detector without loss.

### SUMMARY OF THE INVENTION

A radiation image capturing apparatus of the present invention is an apparatus, including:

a first grid provided with grid structures disposed at intervals and forms a first periodic pattern image by passing radiation emitted from a radiation source;

a second grid provided with grid structures disposed at intervals and forms a second periodic pattern image by receiving the first periodic pattern image;

a radiation image detector that detects the second periodic pattern image formed by the second grid; and

a detector positioning mechanism that adjusts a position of the radiation image detector in an in-plane direction of a detection plane of the detector such that radiation transmitted through the first and second grids falls within the radiation image detector.

In the radiation image capturing apparatus of the present invention, the radiation image detector may be configured to be removably attachable.

Further, the apparatus may include a detector information obtaining unit that obtains size information of the radiation image detector, and the detector positioning mechanism may be a mechanism that adjusts the position of the radiation image detector based on the information obtained by the detector information obtaining unit.

Still further, the first and second grids may be configured to be removably attachable.

Further, the apparatus may further include: a grid information obtaining unit that obtains size information of at least one of the first and second grids; and a grid positioning mechanism that adjusts positions of the first and second grids based on the information obtained by the grid information obtaining unit.

Still further, the grid positioning mechanism may be a mechanism that adjusts the positions of the first and second grids such that a radiation center of the radiation transmits through the centers of the first and second grids substantially perpendicularly.

Further, the detector positioning mechanism may be a mechanism that adjusts the position of the radiation image detector such that a radiation range of the radiation transmitted through the first and second grids on the radiation image detector falls in the center of the detector.

Still further, the apparatus may include a magnification factor obtaining unit that receives and obtains input of a magnification factor for magnification imaging and a magnification imaging moving mechanism that moves the radiation image detector in directions toward and away from a subject, and the detector positioning mechanism may be a mechanism that adjusts the position of the radiation image detector based on the magnification factor obtained by the magnification factor obtaining unit.

Further, the detector positioning mechanism may be a mechanism that moves the radiation image detector according to a position of a subject on an imaging platform.

Still further, the detector positioning mechanism may be a mechanism which includes a detector moving mechanism for moving the radiation image detector.

Further, the detector positioning mechanism may be a mechanism which includes a detector positioning member formed in a shape that positions the radiation image detector into place.

Still further, the grid positioning mechanism may be a mechanism which includes a grid moving mechanism for moving the first and second grids.

Further, the grid positioning mechanism may be a mechanism which includes a grid positioning member formed in a shape that positions the first and second grids into place.

Still further, the apparatus may include: a scanning mechanism that moves at least either one of the first and second grids in a direction orthogonal to an extension direction of the either one of the grids; and an image generation unit that generates an image using radiation image signals representing a plurality of second periodic pattern images detected by the radiation image detector at each position of the either one of the grids along with the movement by the scanning mechanism.

Further, the first and second grids may be disposed such that an extension direction of the first periodic pattern formed by the first grid is inclined relative to an extension direction of the second grid, and the apparatus may include image generation unit that generates an image using a radiation image signal detected by the radiation image detector through exposure of a subject to the radiation.

Still further, the image generation unit may be a unit that obtains radiation image signals read out from different pixel row groups as radiation image signals of different fringe images based on the radiation image signal detected by the radiation image detector, and generates an image based on the obtained radiation image signals of a plurality of fringe images

Further, the apparatus may include an image generation unit that performs a Fourier transform on a radiation image signal detected by the radiation image detector through exposure of a subject to the radiation and generates a phase contrast image based on a result of the Fourier transform.

A radiation image obtaining method of the present invention is a method for obtaining a radiation image using a radiation image capturing apparatus which includes: a first grid provided with grid structures disposed at intervals and forms a first periodic pattern image by passing radiation emitted from a radiation source; a second grid provided with grid structures disposed at intervals and forms a second periodic pattern image by receiving the first periodic pattern image; and a radiation image detector that detects the second periodic pattern image formed by the second grid, the method including the step of:

adjusting a position of the radiation image detector by a detector positioning mechanism in an in-plane direction of a detection plane of the detector such that radiation transmitted through the first and second grids falls within the radiation image detector.

According to the present invention, in a radiation image capturing apparatus which includes first and second grids and a radiation image detector, a position of the radiation image detector in an in-plane direction of a detection plane of the detector is made adjustable by a detector positioning mechanism such that radiation transmitted through the first and second grids falls within the radiation image detector. This allows a radiation range of the radiation transmitted through the first and second grids on the radiation image detector to fall with in the detection plane even when, for example, the size of the radiation image detector is changed or positions of the first and second grids are changed. Thus, radiation transmitted through the first and second grids may be detected by the radiation image detector without loss and a more satisfactory contrast image may be obtained.

Further, the first and second grids are configured to be removably attachable and positions of the first and second grids are adjusted such that a radiation center of the radiation transmits through the centers of the first and second grids substantially perpendicularly. This allows the vignetting of radiation incident on the first and second grids may be reduced even when, for example, the sizes of the first and second grids are changed and a more satisfactory phase contrast image may be obtained.

In the case in which the position of the radiation image detector is adjusted such that a radiation range of the radiation transmitted through the first and second grids on the radiation image detector falls in the center of the radiation image detector, an area of the detection surface of the radiation image detector where image unevenness is not likely to occur may be used, whereby the image quality may be improved.

It is also preferable that the area of the radiation image detector from which image signals are read out is limited to a central area to reduce the signal readout time. The reason is that some subjects can not keep still for a prolonged time and if the image capturing operation is not performed in a short time, an image blur is likely to occur due to displacement (body motion) or sway of the subject. If such image blur occurs during the image capturing operation, the contrast or resolution of a reconstructed phase contrast image may be degraded. But, this arrangement allows reduction in the image blur and acquisition of a satisfactory phase contrast image.

### BRIEF DESCRIPTION OF THE DRAWINGS

FIG. 1 is a schematic configuration diagram of a breast image capturing and display system using a first embodiment of the radiation image capturing apparatus of the present invention.

FIG. 2 is a schematic view illustrating the radiation source, first and second grids, and radiation image detector of the breast image capturing and display system shown in FIG. 1.

FIG. 3 is a top view of the radiation source, first and second grids, and radiation image detector shown in FIG. 2.

FIG. 4 is a schematic configuration diagram of the first grid.

FIG. 5 is a schematic configuration diagram of the second grid.

FIG. 6 is a block diagram of the computer of the breast image capturing and display system shown in FIG. 1, illustrating the internal configuration thereof.

FIG. 7 illustrates an example table that relates cassette information to movement amounts of cassette units.

FIG. 8 is a flowchart illustrating an operation of the breast image capturing and display system using the first embodiment of the radiation image capturing apparatus of the present invention.

FIG. 9 illustrates an example positional relationship between the cassette unit and grid unit.

FIG. 10 illustrates an example movement of the cassette unit.

FIG. 11 illustrates an example movement of the cassette unit.

FIG. 12 illustrates an example movement of the cassette unit.

FIG. 13 illustrates, by way of example, a path of one radiation ray refracted according to a phase shift distribution Φ (x) in X direction of a subject.

FIG. 14 illustrates translation of the second grid.

FIG. 15 illustrates a method of generating a phase contrast image.

FIG. 16 is a schematic configuration diagram of a breast image capturing and display system using a second embodiment of the radiation image capturing apparatus of the present invention.

FIG. 17 is a block diagram of the computer of the breast image capturing and display system shown in FIG. 16, illustrating the internal configuration thereof.

FIG. 18 illustrates an example table that relates grid information to movement amounts of grid units.

FIG. 19 is a flowchart illustrating an operation of the breast image capturing and display system using the second embodiment of the radiation image capturing apparatus of the present invention.

FIG. 20 illustrates an example positional relationship between the cassette unit and grid unit.

FIG. 21 illustrates an example movement of the cassette unit.

FIG. 22 is a schematic configuration diagram of a breast image capturing and display system using an alternative embodiment of the radiation image capturing apparatus of the present invention.

FIG. 23 illustrates an example table that relates cassette information and magnification factors to movement amounts of cassette units.

FIG. 24 illustrates an example case where an image capturing operation is performed by placing a breast on the left side of the imaging platform.

FIG. 25 illustrates an example case where an image capturing operation is performed by placing a breast on the left side of the imaging platform.

FIG. 26 illustrates an example case where an image capturing operation is performed by placing a breast on the left side of the imaging platform.

FIG. 27 illustrates an example case where an image capturing operation is performed by placing a breast on the left side of the imaging platform.

FIG. 28 illustrates an arrangement relationship among the self image of the first grid, second grid, and pixel of the radiation image detector in the case where a plurality of fringe images is obtained by one image capturing operation.

FIG. 29 illustrates how to set an inclination angle of the self image of the first grid relative to the second grid.

FIG. 30 illustrates how to adjust the inclination angle of the self image of the first grid relative to the second grid.

FIG. 31 illustrates how to obtain a plurality of fringe images based on an image signal read from the radiation image detector.

FIG. 32 illustrates how to obtain a plurality of fringe images based on an image signal read from the radiation image detector.

FIGS. 33A to 33C illustrate an example radiation image detector having the function of the second grid.

FIGS. 34A and 34B illustrate an operation for recording a radiation image in the radiation image detector shown in FIGS. 33A to 33C.

FIG. 35 illustrates an operation for reading out a radiation image from the radiation image detector shown in FIGS. 33A to 33C.

FIG. 36 illustrates another example radiation image detector having the function of the second grid.

FIGS. 37A and 37B illustrate an operation for recording a radiation image in the radiation image detector shown in FIG. 36.

FIG. 38 illustrates an operation for reading out a radiation image from the radiation image detector shown in FIG. 36.

FIG. 39 illustrates an alternative shape of the charge storage layer of the radiation image detector shown in FIG. 36.

FIG. 40 illustrates how to generate an absorption image and a small angle X-ray scattering image.

FIG. 41 illustrates a configuration for rotating the first and second grids by 90°.

### DESCRIPTION OF THE PREFERRED EMBODIMENTS

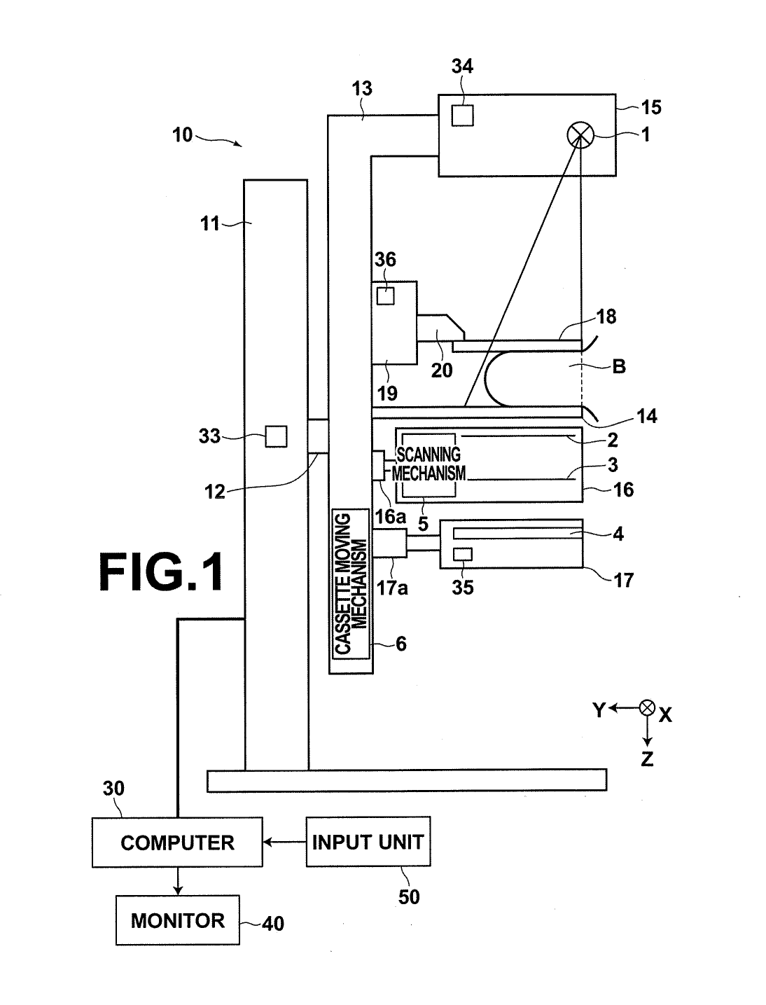

Hereinafter, a breast image capturing and display system using a first embodiment of the radiation image capturing apparatus of the present invention will be described with reference to the accompanying drawings. FIG. 1 is a schematic configuration diagram of a breast image capturing and display system using a first embodiment of the radiation image capturing apparatus of the present invention, illustrating an overview thereof.

As shown in FIG. 1, the breast image capturing and display system includes breast image capturing apparatus 10, computer 30 connected to breast image capturing apparatus 10, and monitor 40 and input unit 50 connected to computer 30.

Breast image capturing apparatus 10 includes base 11, rotary shaft 12 which is movable in up and down directions with respect to base 11 (Z directions), as well as being rotatable, and arm 13 coupled to base 11 via rotary shaft 12.

Arm 13 has a shape of an alphabet C, and imaging platform 14 for placing breast B is provided on one side thereof and radiation source unit 15 is provided on the other side so as to face the imaging platform 14. The movement of arm 13 in up and down directions is controlled by arm controller 33 built in based 11.

Further, grid unit 16 and cassette unit 17 are arranged on the opposite side of the breast placement surface of imaging platform 14 in this order.

Grid unit 16 is coupled to arm 13 via grid support 16a and includes therein first grid 2, second grid 3, and scanning mechanism 5, to be described later in detail.

In the present embodiment, it is assumed that grid unit 16 is fixed by grid support 16a at a position where the radiation center of radiation emitted from radiation source 1 of radiation source unit 15, to be described later, may transmit through the centers of first grid 2 and second grid 3 in grid unit 16 substantially perpendicularly.

Cassette unit 17 is coupled to arm 13 via cassette support 17a that supports cassette unit 17 and allows cassette unit 17 to be removably attached.

In the present embodiment, cassette unit 17 is configured to be attachable to and removable from cassette support 17a, thereby being made to be removably attachable. But, for example, cassette unit 17 may be configured to be fixedly attached to arm 13 and withdrawable from the optical path of the radiation in order to be moved into and out of the optical path of the radiation, whereby cassette unit 17 may be made to be removably attachable.

In the present embodiment, it is also assumed that a plurality of types of cassette units 17 of different sizes is configured to be removably attachable.

Cassette unit 17 includes therein radiation image detector 4, such as a flat panel detector or the like, and detector controller 35 for controlling reading of a charge signal from radiation image detector 4 and the like. Although omitted in the drawing, cassette unit 17 also includes therein a circuit board on which a charge amplifier for converting charge signals readout from the radiation image detector 4 to voltage signals, a correlated double sampling circuit for sampling the voltage signals outputted from the charge amplifier, an A/D converter for converting the voltage signals to digital signals, and the like are provided.

Radiation image detector 4 includes pixels disposed two dimensionally to allow repetitions of recording and reading of radiation images. As for radiation image detector 4, a so-called direct type radiation image detector that directly receives radiation to generate electric charges or a so-called indirect type radiation image detector that receives visible light converted from radiation to generate electric charges may be used. As for the readout method, a so-called TFT (thin film transistor) readout method in which radiation image signals are read by switching ON/OFF the TFT switches or an optical readout method in which a radiation image signal is read out by directing readout light to the detector is preferably used, but other methods may also be used. In the case of an optical readout radiation image detector having a multiple linear electrodes and an image signal is read by scanning a linear readout light in a direction in which the linear electrodes are extended, it is assumed that each linear electrode for reading a signal of one pixel constitutes a pixel row and a reading pitch of the readout light constitutes a pixel column.

Cassette support 17a to which cassette unit 17 is attached may be telescopic in Y directions shown in FIG. 1 and movable in X directions. Cassette moving mechanism 6 is provided inside of arm 13 to telescopically move cassette support 17a in Y directions, as well as moving the support in X directions according to a control signal from computer 30.

That is, cassette support 17a is telescopically extended or retracted in Y directions and moved in X directions by cassette moving mechanism 6 to move radiation image detector 4 provided in cassette unit 17 in in-plane directions of detection surface (X-Y surface). Cassette moving mechanism 6 may be constructed with a known actuator.

Radiation source unit 15 includes therein radiation source 1 and radiation source controller 34. Radiation source controller 34 controls the timing of radiation emission from radiation source 1 and radiation generation conditions (tube current, exposure time, tube voltage, and the like) for radiation source 1.

Further, compression paddle 18 disposed above imaging platform 14 to hold and compress a breast, compression paddle support 20 for supporting compression paddle 18, and compression paddle moving mechanism 19 for moving compression paddle support 20 in up and down directions (Z directions) are provided at arm 13. The position of compression paddle 18 and compression pressure are controlled by compression paddle controller 36.

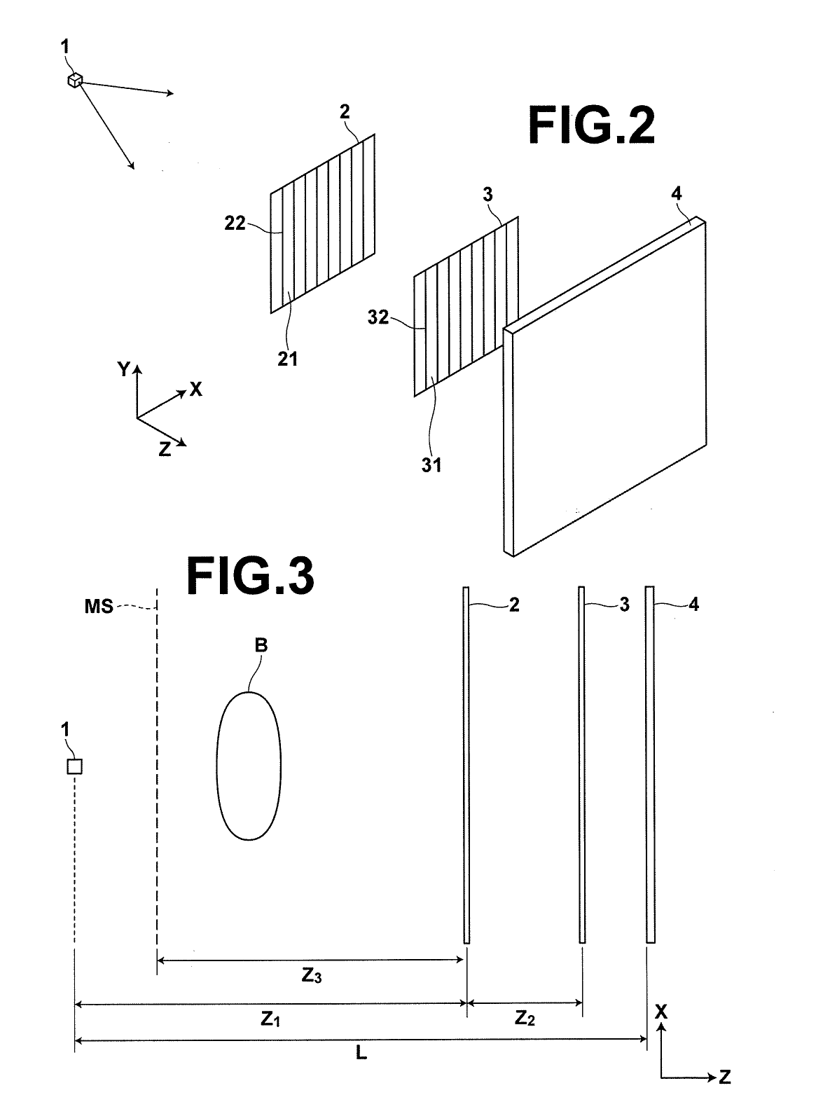

The breast image capturing and display system of the present embodiment is a system for capturing a phase contrast image of a breast B using first grid 2, second grid 3, and radiation image detector 4. Now, a configuration of radiation source 1, first grid 2, and second grid 3 required for capturing the phase contrast image will be described in detail. FIG. 2 illustrates only radiation source 1, first grid 2, second grid 3, and radiation image detector 4 extracted from FIG. 1. FIG. 3 schematically illustrates radiation source 1, first grid 2, second grid 3, and radiation image detector 4 shown in FIG. 2 viewed from above.

Radiation source 1 emits radiation toward the breast B and has enough spatial coherence to cause Talbot interference effect when radiation is incident on first grid 2. For example, a micro focus X-ray tube having a small radiation emission point or a plasma X-ray source may be used for this purpose. In the case where a radiation source having a relatively large radiation emission point (so-called focus spot size), like that used in general medical practice, is used, a multi-slit having a given pitch may be disposed on the emission side of the radiation. The detailed configuration in this case is described, for example, in “Phase retrieval and differential phase-contrast imaging with low-brilliance X-ray sources” by Franz Pfeiffer, Timm Weikamp, Oliver Bunk, and Christian David, Nature Physics 2, Letters, 258-261(1 Apr. 2006), and pitch P₀ of the slit MS should satisfy Formula (1) given below.

P₀=P₂×Z₃/Z₂ (1)

where, P₂ is a pitch of second grid 3, Z₃ is a distance from the position of the multi-slit MS to first grid 2, as shown in FIG. 3, and Z₂ is a distance from first grid 2 to second grid 3.

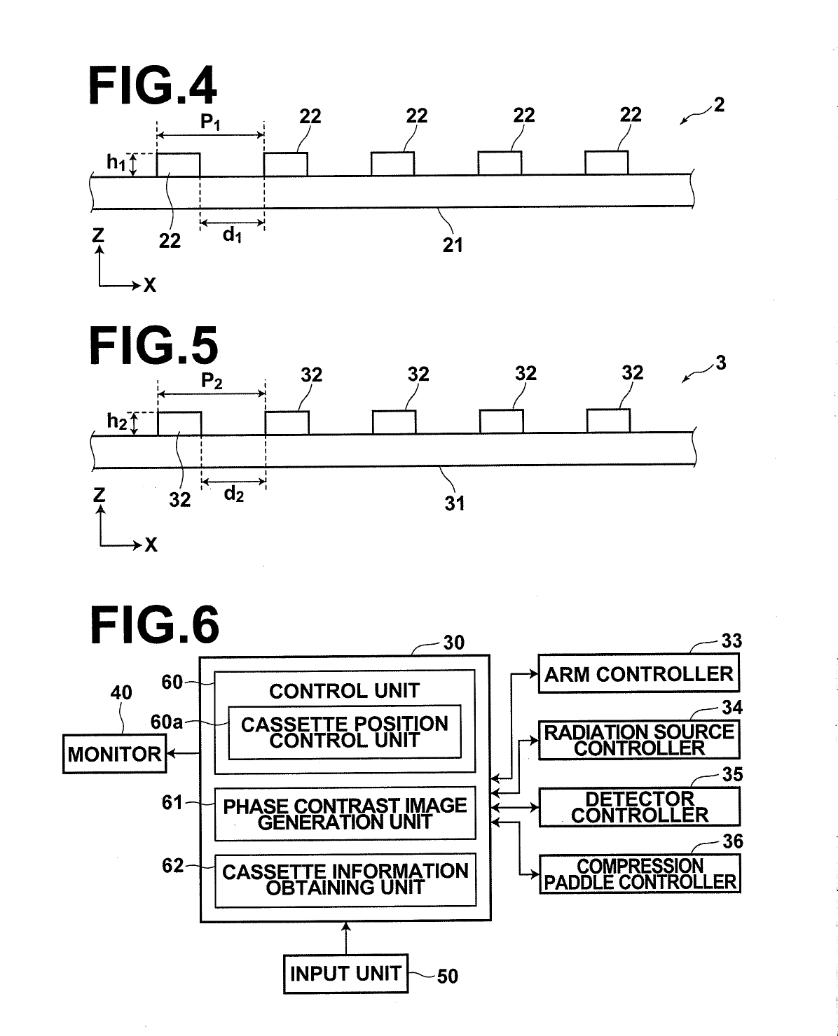

First grid 2 transmits radiation emitted from radiation source 1 to form a first periodic pattern image. The grid includes substrate 21 that primarily transmits radiation and a plurality of members 22 provided on substrate 21, as shown in FIG. 4. Each of the plurality of members 22 is a linear member extending in one in-plane direction (Y direction orthogonal to X and Z directions, i.e., thickness direction of FIG. 4) orthogonal to the optical axis of radiation. The plurality of members 22 is disposed in X direction at constant pitch P₁ with a predetermined distance d₁ between each member. As for the material of members 22, for example, a metal such as gold or platinum may be used. Preferably, first grid 2 is a so-called phase modulation grid that produces a phase modulation of about 90° or about 180° in the projected radiation. Assuming, for example, that member 22 is made of gold, the thickness h₁ of each member in the energy range of X ray used for general medical diagnosis is one micrometer to ten micrometers. Further, an amplitude modulation grid may also be used. In this case, each member 22 needs to have a thickness that allows sufficient absorption of radiation. Assuming, for example, that member 22 is made of gold, the thickness h₁ of the member in the energy range of X ray used for general medical diagnosis is ten to several hundreds of micrometers.

Second grid 3 intensity modulates the first periodic pattern image formed by first grid 2 to form a second periodic pattern image. As illustrated in FIG. 5, second grid 3 includes substrate 31 that primarily transmits radiation and a plurality of members 32 provided on substrate 31, as in first grid 2. The plurality of members 32 blocks radiation and each of them is a linear member extending in one in-plane direction (Y direction orthogonal to X and Z directions, i.e., thickness direction of FIG. 5) orthogonal to the optical axis of radiation. The plurality of members 32 is disposed in X direction at constant pitch P₂ with a predetermined distance d₂ between each member. As for the material of members 32, for example, a metal such as gold or platinum may be used. Preferably, second grid 3 is an amplitude modulation grid. Each member 32 needs to have a thickness that allows sufficient absorption of radiation. Assuming, for example, that member 32 is made of gold, the thickness h₂ of the member in the energy range of X ray used for general medical diagnosis is ten to several hundreds of micrometers.

Here, in the case where radiation emitted from radiation source 1 is a cone beam instead of a parallel beam, a self image G1 of first grid 2 formed by radiation transmitted through first grid 2 is enlarged in proportion to the distance from radiation source 1. In the present embodiment, the grid pitch P₂ and distance d₂ of second grid 3 are determined such that the slit section thereof substantially corresponds to the periodic pattern of the bright portions of the self image G1 of first grid 2 at the position of second grid 3. That is, if the distance from the focal point of radiation source 1 to first grid 2 is taken as Z₁, and the distance from first grid 2 to second grid 3 is taken as Z₂, in the case where the first grid 2 is a phase modulation grid that applies phase modulation of 90° or an amplitude modulation grid, pitch P₂ of second grid 3 is determined so as to satisfy Formulae (2) given below.

$${P}_{2} = {P}_{1}^{′} = \frac{{Z}_{1} + {Z}_{2}}{{Z}_{1}} {P}_{1} \qquad ( 2 )$$

where P₁′ is a pitch of the self image G1 formed by the first grid 2 at the position of the second grid 3. Alternatively, in the case where the first grid 2 is a phase modulation grid that applies phase modulation of 180°, the pitch P₂ of the second grid is determined to satisfy the relationship defined as the Expressions (3) below:

$${P}_{2} = {P}_{1}^{′} = \frac{{Z}_{1} + {Z}_{2}}{{Z}_{1}} \cdot \frac{{P}_{1}}{2} \qquad ( 3 )$$

In the case where radiation emitted from radiation source 1 is a parallel beam, if the first grid 2 is a 90° phase modulation grid or an amplitude modulation grid, the pitch P₂ of second grid 3 is determined to satisfy:

P₂=P₁

or if, the first grid 2 is an 180° phase modulation grid, the pitch P₂ of second grid 3 is determined to satisfy:

P₂=P₁/2

In order for breast image capturing apparatus 10 to function as a Talbot interferometer, some other conditions may also be substantially satisfied, which will be described hereinafter.

First of all, the grid surfaces of first grid 2 and second grid 3 should be parallel to the X-Y plane shown in FIG. 2.

In the case where first grid 2 is a phase modulation grid that produces a phase modulation of 90°, the following condition should be substantially satisfied.

$${Z}_{2} = ( m + \frac{1}{2} ) \frac{{P}_{1} {P}_{2}}{λ} \qquad ( 4 )$$

where, λ is a wavelength of the radiation (normally, effective wavelength), m is 0 or a positive integer, P₁ is a grid pitch of first grid 2 described above, and P₂ is a grid pitch of second grid 3 described above.

In the case where first grid 2 is a phase modulation grid that produces phase modulation of 180°, the following condition should be substantially satisfied.

$${Z}_{2} = ( m + \frac{1}{2} ) \frac{{P}_{1} {P}_{2}}{2 λ} \qquad ( 5 )$$

where, λ is a wavelength of the radiation (normally, effective wavelength), m is 0 or a positive integer, P₁ is a grid pitch of first grid 2 described above, and P₂ is a grid pitch of second grid 3 described above.

In the case where first grid 2 is an amplitude modulation grid, the following condition should be substantially satisfied.

$${Z}_{2} = {m}^{′} \frac{{P}_{1} {P}_{2}}{λ} \qquad ( 6 )$$

where, λ is a wavelength of the radiation (normally, effective wavelength), m′ is 0 or a positive integer, P₁ is a grid pitch of first grid 2 described above, and P₂ is a grid pitch of second grid 3 described above.

Formulae (4), (5), and (6) are applied to the case where radiation emitted from radiation source 1 is a cone beam, and if the radiation is a parallel beam, Formulae (7), (8), and (9) are applied instead of Formulae (4), (5), and (6) respectively.

$$\begin{matrix}{Z}_{2} = ( m + \frac{1}{2} ) \frac{{P}_{1}^{2}}{λ} & ( 7 ) \\ {Z}_{2} = ( m + \frac{1}{2} ) \frac{{P}_{1}^{2}}{4 λ} & ( 8 ) \\ {Z}_{2} = {m}^{′} \frac{{P}_{1}^{2}}{λ} & ( 9 )\end{matrix}$$

Further, as illustrated in FIGS. 4 and 5, members 22 of first grid are formed with a thickness of h₁ and members 32 of second grid are formed with a thickness of h₂, and overly thick members 22 and 32 cause radiation rays obliquely incident on first grid 2 and second grid 3 to become difficult to pass through the slit sections, i.e., cause a so-called vignetting phenomenon, posing a problem that the effective field of view in the direction orthogonal to the direction in which members 22 and 32 are extended (X direction) is reduced. Consequently, it is preferred to define upper limits for thicknesses h₁ and h₂ from the viewpoint of ensuring a satisfactory field of view. In order to ensure effective field of view V in the X direction on the detection surface of radiation image detector 4, thicknesses h₁ and h₂ should be set to values that satisfy Formulae (10) and (11) respectively, in which L is a distance from the focal point of radiation source 1 to the detection surface of radiation image detector 4 (FIG. 3).

$$\begin{matrix}{h}_{1} \leq \frac{L}{V / 2} {d}_{1} & ( 10 ) \\ {h}_{2} \leq \frac{L}{V / 2} {d}_{2} & ( 11 )\end{matrix}$$

Scanning mechanism 5 provided in grid unit 16 changes the relative position between first grid 2 and second grid 3 by translating second grid 3 in the direction orthogonal to the direction in which members 32 thereof are extended (X direction). Scanning mechanism 5 is formed of an actuator, such as a piezoelectric device. Then, at each position of second grid 3 translated by scanning mechanism 5, a second periodic pattern image formed by second grid 3 is detected by radiation image detector 4.

FIG. 6 is a block diagram of computer 30 shown in FIG. 1, illustrating the configuration thereof. Computer 30 includes a central processing unit (CPU) and a storage device, such as a semiconductor memory, hard disk, or SSD, and such hardware forms control unit 60, phase contrast image generation unit 61, and cassette information obtaining unit 62.

Control unit 60 performs overall control of the system by outputting predetermined control signals to various types of controllers 33 to 36. Control unit 60 also includes cassette position control unit 60a.

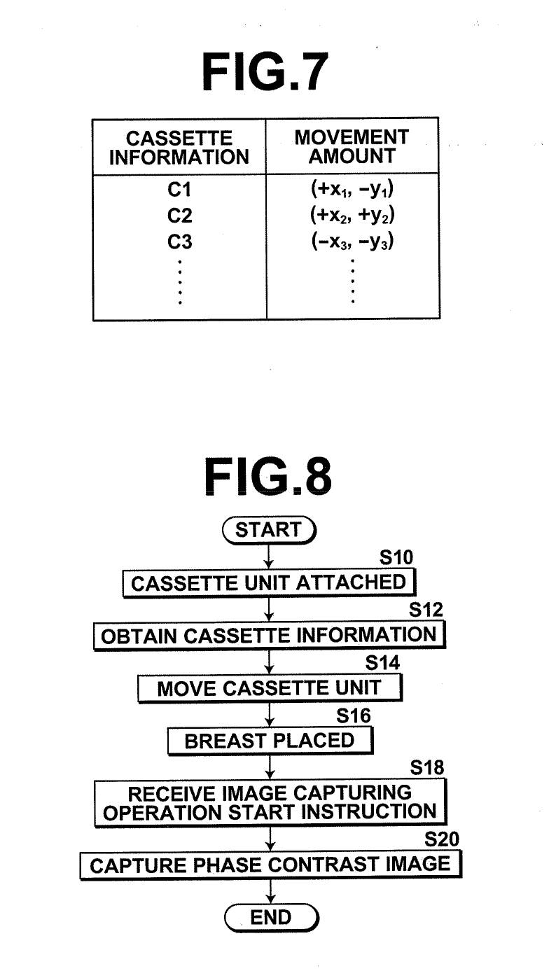

Cassette position control unit 60a causes cassette moving mechanism 6 provided in arm 13 to move cassette unit 17 in X-Y directions by outputting a control signal to cassette moving mechanism 6 based on cassette information obtained by cassette information obtaining unit 62. More specifically, cassette position control unit 60a includes therein a preset table that relates cassette information to movement amounts of cassette unit 17 in X-Y directions as illustrated in FIG. 7. Cassette position control unit 60a receives cassette information, refers to the table based on the received cassette information to obtain a movement amount corresponding to the cassette information, and outputs a control signal according to the movement amount to cassette moving mechanism 6.

In the present embodiment, it is assumed that the table includes movement amounts that cause radiation transmitted through first grid 2 and second grid 3 is incident on the center of radiation image detector 4 in cassette unit 17. But the movement amounts may not necessarily be limited to those and the table may include any movement amount that causes radiation transmitted through first grid 2 and second grid 3 is incident on a position within the detection surface of radiation image detector 4 in cassette unit 17. Note that the movement amounts are those of cassette unit 17 from a predetermined default position thereof. Specific examples of the movement of cassette unit 17 will be described later.

Phase contrast image generation unit 61 may generate a radiation phase contrast image based on image signals of a plurality of different fringe images detected by radiation image detector 4 with respect to each position of second grid 3. The method of generating the radiation phase contrast image will be described in detail later.

Cassette information obtaining unit 62 may obtain cassette information inputted by the radiological technologist via input unit 50. Cassette information inputted by the radiological technologist differs depending on the sizes of radiation image detector 4 inside of cassette unit 17 in X and Y directions. Sizes of radiation image detectors 4 may include but not limited to 18 cm×24 cm, 24 cm×30 cm, 17 in (43.2 cm)×17 in (43.2 cm), 17 in (43.2 cm)×14 in (35.6 cm), and 9 in (22.9 cm)×9 in (22.9 cm).

In the present invention, cassette information is set and entered, but the sizes of radiation image detector in X and Y directions may be directly set and entered. Further, in the present embodiment, cassette information is set and entered by the radiological technologist, but cassette information may be obtained by presetting cassette information in cassette unit 17 and reading the cassette information by cassette information obtaining unit 62.

Monitor 40 may display the phase contrast image generated by phase contrast image generation unit 61 of computer 30.

Input unit 50 includes, for example, a pointing device, such as a keyboard or a mouse, to receive input, including imaging conditions, an image capturing operation start instruction, and the like, from the radiological technologist. In the present embodiment, in particular, the input unit is used for receiving input such as the cassette information described above.

An operation of the breast image capturing and display system of the present embodiment will now be described with reference to the flowchart shown in FIG. 8.

First, a desired cassette unit 17 is selected by the radiological technologist from various types of cassette units 17 of different sizes according to the size of the breast B and imaging techniques, and selected cassette unit 17 is attached to cassette support 17a (S10).

Then, cassette information of cassette unit 17 attached to cassette support 17a is entered by the radiological technologist via input unit 50, and the entered cassette information is obtained by cassette information obtaining unit 62 (S12).

The cassette information obtained by cassette information obtaining unit 62 is outputted to cassette position control unit 60a, and cassette position control unit 60a refers to the table shown in FIG. 7 to obtain a movement amount of cassette unit 17 based on entered cassette information and outputs a control signal to cassette moving mechanism 6 according to the movement amount. Cassette moving mechanism 6 moves cassette unit 17 by moving cassette support 17a according to the inputted control signal (S14). More specifically, cassette unit 17 is moved such that radiation transmitted through first grid 2 and second grid 3 in grid unit 16 is incident on the center of radiation image detector 4 in cassette unit 17 as described above.

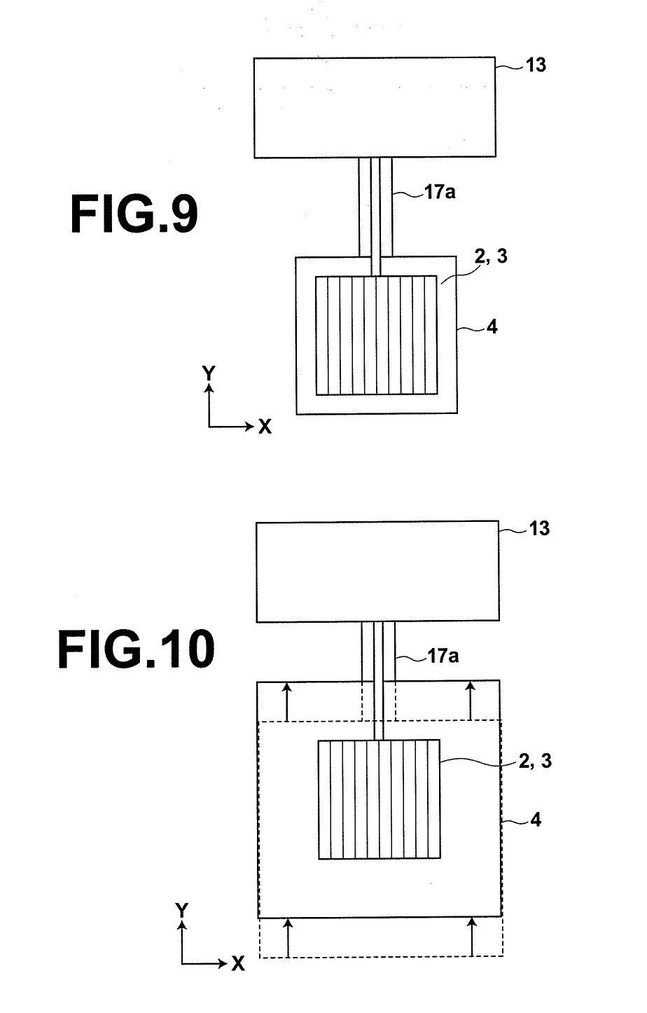

For example, in the case where cassette unit 17 disposed such that first grid 2 and second grid 3 in grid unit 16 are placed at a position corresponding to the center of the detection surface of radiation image detector 4 in cassette unit 17 in the previous image capturing operation, as illustrated in FIG. 9, is replaced with relatively large cassette unit 17 in the present image capturing operation, as illustrated by the dotted line in FIG. 10, first grid 2 and second grid 3 in grid unit 16 will be out of the position corresponding to the center of the detection surface of radiation image detector 4 in cassette unit 17.

Consequently, cassette support 17a is shortened by cassette moving mechanism 6 to move cassette unit 17 such that the position of radiation image detector 4 is changed from the position indicated by the dotted line to the position indicated by the solid line, as shown in FIG. 10, thereby causing first grid 2 and second grid 3 in grid unit 16 to be placed at a position corresponding to the center of the detection surface of radiation image detector 4. This allows radiation transmitted through first grid 2 and second grid 3 in grid unit 16 to be incident on the center of detection surface of radiation image detector 4 in cassette unit 17.

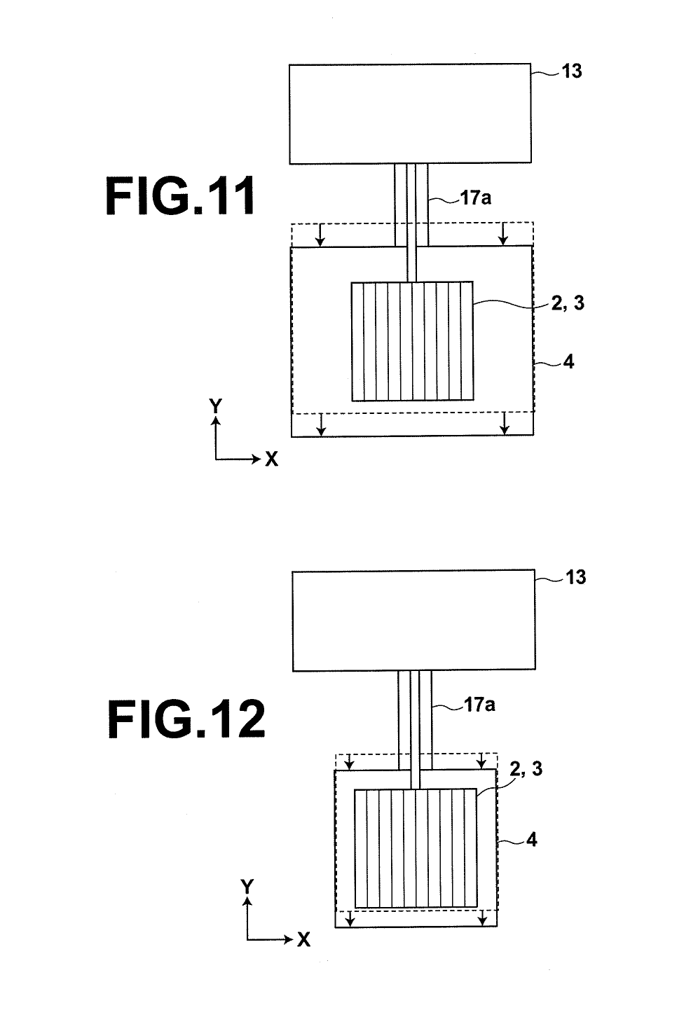

In the case where cassette unit 17 shown in FIG. 10 is replaced with rectangular cassette unit 17 as illustrated in FIG. 11, and the position of cassette unit 17 with respect to first grid 2 and second grid 3 becomes the position indicated by the dotted line in FIG. 11, cassette support 17a is lengthened by cassette moving mechanism 6 to move cassette unit 17 such that the position of radiation image detector 4 is changed from the position indicated by the dotted line to the position indicated by the solid line, as shown in FIG. 11, thereby causing first grid 2 and second grid 3 in grid unit 16 to be placed at a position corresponding to the center of the detection surface of radiation image detector 4.

In the case where cassette unit 17 shown in FIG. 11 is replaced with a relatively small cassette unit 17 as illustrated in FIG. 12 and the position of cassette unit 17 with respect to first grid 2 and second grid 3 becomes the position indicated by the dotted line in FIG. 12, cassette support 17a is further lengthened by cassette moving mechanism 6 to move cassette unit 17 such that the position of radiation image detector 4 is changed from the position indicated by the dotted line to the position indicated by the solid line, as shown in FIG. 12, thereby causing first grid 2 and second grid 3 in grid unit 16 to be placed at a position corresponding to the center of the detection surface of radiation image detector 4.

Then, after the position of cassette unit 17 is adjusted in the manner as described above, a phase contrast image capturing operation is initiated. More specifically, a breast B of a patient is placed on the imaging platform 14 and the breast B is compressed by compression paddle 18 at a predetermined pressure (S16).

Next, an image capturing operation start instruction for a phase contrast image is entered by the radiological technologist via input unit 50 (S18), and the image capturing operation is initiated in response to the image capturing operation start instruction (S20).

First, radiation is emitted from radiation source 1 and the radiation transmits through the breast B and incident on first grid 2. The radiation incident on first grid 2 is diffracted by first grid 2 and a Talbot interference image is formed at a given distance from first grid 2 in the optical axis direction of the radiation.

This phenomenon is known as the Talbot effect, and a self image G1 of first grid 2 is formed at a given distance from first grid 2 when a radiation wave-front passes through first grid 2. For example, in the case where first grid 2 is a phase modulation grid that produces a phase modulation of 90°, a self image G1 is formed at a distance given by Formula (4) or Formula (7) above (where first grid 2 is a phase modulation grid that produces a phase modulation of 180°, Formula (5) or Formula (8), and where first grid 2 is an intensity modulation grid, Formula (6) or Formula (9)), in which the wave-front incident on first grid 2 is distorted by the subject, i.e., breast image B, and therefore the self image G1 of first grid 2 is deformed accordingly.

Thereafter, the radiation passes through second grid 3. As a result, the deformed self image G1 of first grid 2 is subjected to intensity modulation due to superimposition with second grid 3 and detected by radiation image detector 4 as an image signal reflecting the wave-front distortion described above. The image signal detected by radiation image detector 4 is inputted to phase contrast image generation unit 61 in computer 30.

Next, a method of generating a phase contrast image in phase contrast image generation unit 61 will be described. But, to begin with, the principle of the phase contrast image generation method in the present embodiment will be described.

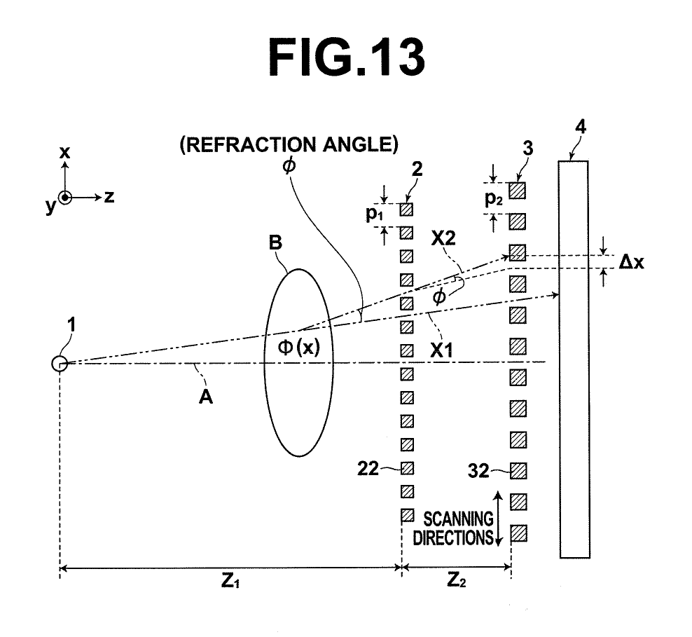

FIG. 13 illustrates a path of one radiation ray refracted according to a phase shift distribution Φ (x) with respect to X direction of the subject B. The reference symbol X1 denotes a straight path of the radiation ray in the absence of the subject B, and the radiation ray propagating through path X1 is incident on radiation image detector 4 after transmitting through first grid 2 and second grid 3. Reference symbol X2 denotes, in the case where the subject B is present, a path of deflected radiation ray due to refraction by the subject B. The radiation ray propagating through path X2 is blocked by second grid 3 after passing through first grid 2.

The phase shift distribution Φ (x) of the subject B is expressed by Formula (12) given below taking n (x, z) as the refractive index distribution of the subject B and z as the direction in which the radiation propagates. Here, y coordinate is omitted for the sake of convenience of explanation.

$$Φ ( x ) = \frac{2 π}{λ} \int [ 1 - n ( x , z ) ] d z \qquad ( 12 )$$

Self image G1 of first grid 2 formed at the position of second grid 3 is displaced in X direction due to refraction of the radiation ray at the subject B in an amount according to the refraction angle φ. The amount of displacement Δx may be approximated by Formula 13 given below based on the fact that the refraction angle φ is very small.

Δx≈Z₂φ (13)

where, the refraction angle φ may be expressed by Formula (14) given below using wavelength λ of the radiation ray and phase shift distribution Φ (x) of the subject B.

$$ϕ = \frac{λ}{2 π} \frac{\partial Φ ( x )}{\partial x} \qquad ( 14 )$$

As described above, the amount of displacement Δx of the self image G1 due to refraction of the radiation ray at the subject B is linked to the phase shift distribution Φ (x). Then, the amount of displacement Δx is linked to the phase shift amount Ψ of intensity modulated signal of each pixel (phase shift amount in intensity modulated signal of each pixel between the presence and absence of the subject B) detected by radiation image detector 4 in the manner represented by Formula (15) given below.

$$ψ = \frac{2 π}{{P}_{2}} Δ x = \frac{2 π}{{P}_{2}} {Z}_{2} ϕ \qquad ( 15 )$$

Accordingly, by obtaining the phase shift amount Ψ in the intensity modulated signal of each pixel, the refraction angle φ may be obtained by Formula (15), and a differential amount of the phase shift distribution Φ (x) may be obtained using Formula (14) given above. By integrating the differential amount with respect to x, the phase shift distribution Φ (x) of the subject B may be obtained, that is, the phase contrast image of the subject B may be generated. In the present embodiment, the phase shift amount Ψ is calculated by a fringe scanning method described below.

In the fringe scanning method, an image capturing operation described above is performed by translating either one of first grid 2 and second grid 3 relative to the other in X direction. In the present embodiment, second grid 3 is moved by scanning mechanism 5 described above. As second grid 3 is moved, the fringe image detected by radiation image detector 4 is moved and when a translation distance (movement amount in X direction) reaches one arrangement period of second grid 3 (arrangement pitch P₂), that is, when the phase variation between the self image G1 of first grid 2 and second grid 3 reaches 2π, the fringe image returns to the original position. A fringe image is detected by radiation image detector 4 each time second grid 3 is moved by an amount of arrangement pitch P₂ divided by an integer, and intensity modulated signals of each pixel are obtained from a plurality of detected fringe images to obtain an phase shift amount Ψ in the intensity modulated signals of each pixel.

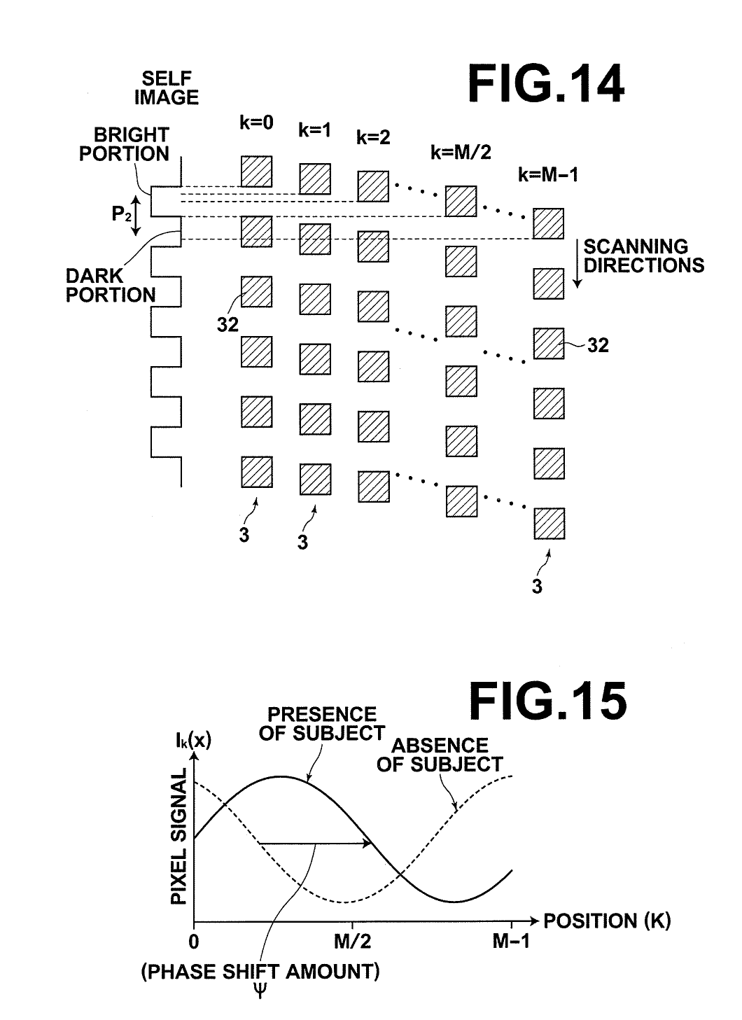

FIG. 14 schematically illustrates the movement of second grid 3 in increments of P₂/M, in which P₂ is the arrangement pitch of second grid 3 and M is an integer of two or greater. Scanning mechanism 5 sequentially translates second grid 3 to each of M positions of k=0, 1, 2, - - - , and M−1 to which second grid 3 is to be moved. Although FIG. 14 indicates that the initial position of second grid 3 is at a position where dark portions of self image G1 of first grid 2 at second grid 3 substantially correspond to members 32 of second grid 3 (k=0), the initial position may be any of the positions k−=0, 1, 2, - - - , and M−1.

At the position of k=0, the component of radiation not refracted by the subject B is mainly passed through second grid 3. Then, as second grid 3 is sequentially moved to positions k=0, 1, - - - , the radiation component not refracted by the subject B is decreased while the radiation component refracted by the subject is increased in the radiation passing through the second grid 3. In particular, at the position k=M/2, the radiation component refracted by the subject Bm is mainly passed through second grid 3. Then, after the position k=M/2, the radiation component refracted by the subject B is decreased while the radiation component not refracted by the subject is increased.

At each of the positions k=1, 2, - - - , and M−1, an image capturing operation is performed with radiation image detector 4 to obtain image signals of M fringe images and the fringe image signals are stored in phase contrast image generation unit 61.

A method of calculating a phase shift amount Ψ of intensity modulated signal of each pixel from pixel signals of each pixel of the image signals of M fringe images will now be described.

First, the pixel signal Ik (x) of each pixel at the position k of second grid 3 may be represented by Formula (16) given below.

$${I}_{k} ( x ) = {A}_{0} + {\sum }_{n > 0}^{ } {A}_{n} exp [ 2 π i \frac{n}{{P}_{2}} \{ {Z}_{2} ϕ ( x ) + \frac{{kP}_{2}}{M} \} ] \qquad ( 16 )$$

where, x is the coordinate of the pixel in x direction, A₀ is the intensity of incident radiation, and Aₙ is the value corresponding to the contrast of the intensity modulated signal (n is a positive integer, here). The φ (x) is the representation of the refraction angle φ as a function of the coordinate x of the pixel of radiation image detector 4.

Then, the use of the relationship represented by Formula (17) given below may result in that the refraction angle φ (x) is expressed as Formula (18) given below.

$$\begin{matrix}{\sum }_{k = 0}^{M - 1} exp ( - 2 π i \frac{k}{M} ) = 0 & ( 17 ) \\ ϕ ( x ) = \frac{{p}_{2}}{2 π {Z}_{2}} arg [ {\sum }_{k = 0}^{M - 1} {I}_{k} ( x ) exp ( - 2 π i \frac{k}{M} ) ] & ( 18 )\end{matrix}$$

where, arg [ ] implies extraction of an argument corresponding to the phase shift amount Ψ of each pixel of radiation image detector 4. Therefore, the refraction angle φ (x) may be obtained by calculating the phase shift amount Ψ of intensity modulated signal of each pixel from M fringe image signals obtained based on Formula (18).

More specifically, as illustrated in FIG. 15, the M fringe image signals obtained from each pixel of radiation image detector 4 varies periodically with respect to the position k of second grid 3. The broken line in FIG. 15 indicates a pixel signal variation in the absence of the subject B while the solid line indicates a pixel signal variation in the presence of the subject B. The phase difference between the two waveforms corresponds to the phase shift amount Ψ of intensity modulated signal of each pixel.

As the refraction angle φ (x) is a value corresponding to a differential value of the phase shift distribution Φ (x) as indicated by Formula (14) above, the phase shift distribution Φ (x) may be obtained by integrating the refraction angle φ (x) along x axis.

In the description above, y coordinate of pixel in y direction is not considered, but an identical calculation may be made for each y coordinate, whereby a two-dimensional distribution of refraction angles φ (x, y) may be obtained, Then, by integrating the two-dimensional distribution of refraction angles φ (x, y) along x axis, a two-dimensional phase shift distribution Φ (x, y) may be obtained as a phase contrast image.

Further, the phase contrast image may be generated by integrating the two-dimensional distribution of phase shift amounts Ψ (x, y) along x axis, instead of the two-dimensional distribution of refraction angles φ (x, y).

The two-dimensional distribution of refraction angles φ (x, y) or two-dimensional distribution of phase shift amounts (x, y) is known as a differential phase image as they correspond to differential values of phase shift distribution Φ (x, y), and the differential phase image may be generated as the phase contrast image.

As described above, a phase contrast image is generated in phase contrast image generation unit 61 based on a plurality of fringe images.

Then, the phase contrast image generated in phase contrast image generation unit 61 is outputted to monitor 40 and displayed thereon.

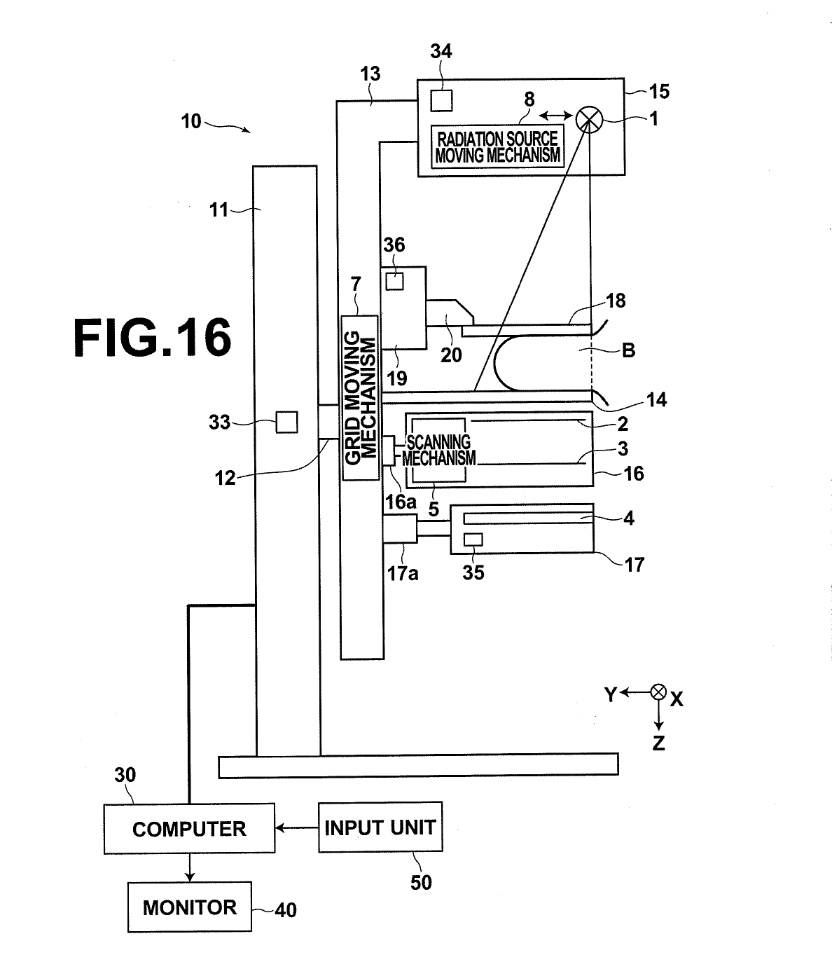

Next, a breast image capturing and display system using a second embodiment of the radiation image capturing apparatus of the present invention will be described. FIG. 16 is a schematic configuration diagram of a breast image capturing and display system using a second embodiment of the radiation image capturing apparatus of the present invention, illustrating an overview thereof.

The breast image capturing and display system of the second embodiment differs from the breast image capturing and display system of the first embodiment in that, whereas the cassette unit 17 is movably constructed in the first embodiment, the position of cassette unit 17 is fixed and grid unit 16 and radiation source 1 are movably constructed. Since other structures are identical to those of the first embodiment, only the structure different from that of the first embodiment will be described.

Grid unit 16 of the present embodiment is coupled to arm 13 via grid support 16a that may support grid unit 16 and allow grid unit 16 to be removably attached. Grid support 16a is configured such that a plurality of types of grid units 16 having different sizes may be removably attached.

In the present embodiment, grid unit 16 is configured to be attachable to and removable from grid support 16a, thereby being made to be removably attachable. But, for example, grid unit 16 may be configured to be fixedly attached to arm 13, and withdrawable from the optical path of the radiation in order to be moved into and out of the optical path of the radiation, whereby grid unit 16 may be made to be removably attachable. That is, the term “removably attachable structure” as used herein may include not only the structure that allows grid unit 16 to be attached to and removed from grid support 16a but also the aforementioned withdrawable structure.

Grid support 16a to which grid unit 16 is attached may be telescopic in Y directions shown in FIG. 16 and movable in X directions. Grid moving mechanism 7 is provided inside of arm 13 to telescopically move grid support 16a in Y directions, as well as moving the support in X directions according to a control signal from computer 30.

That is, grid support 16a is telescopically extended or retracted in Y directions and moved in X directions by grid moving mechanism 7 to move first grid 2 and second grid 3 provided in grid unit 16 in in-plane directions of grid surface (X-Y surface). Grid moving mechanism 7 may be constructed with a known actuator.

Further, radiation source moving mechanism 8 for moving radiation source 1 according to the movement of grid unit 16 is provided in radiation source unit 15. More specifically, source moving mechanism 8 moves radiation source 1, when grid unit 16 is moved, according to the movement of grid unit 16 such that the radiation center of radiation emitted from radiation source 1 transmits through the center of first grid 2 and second grid 3 substantially perpendicularly.

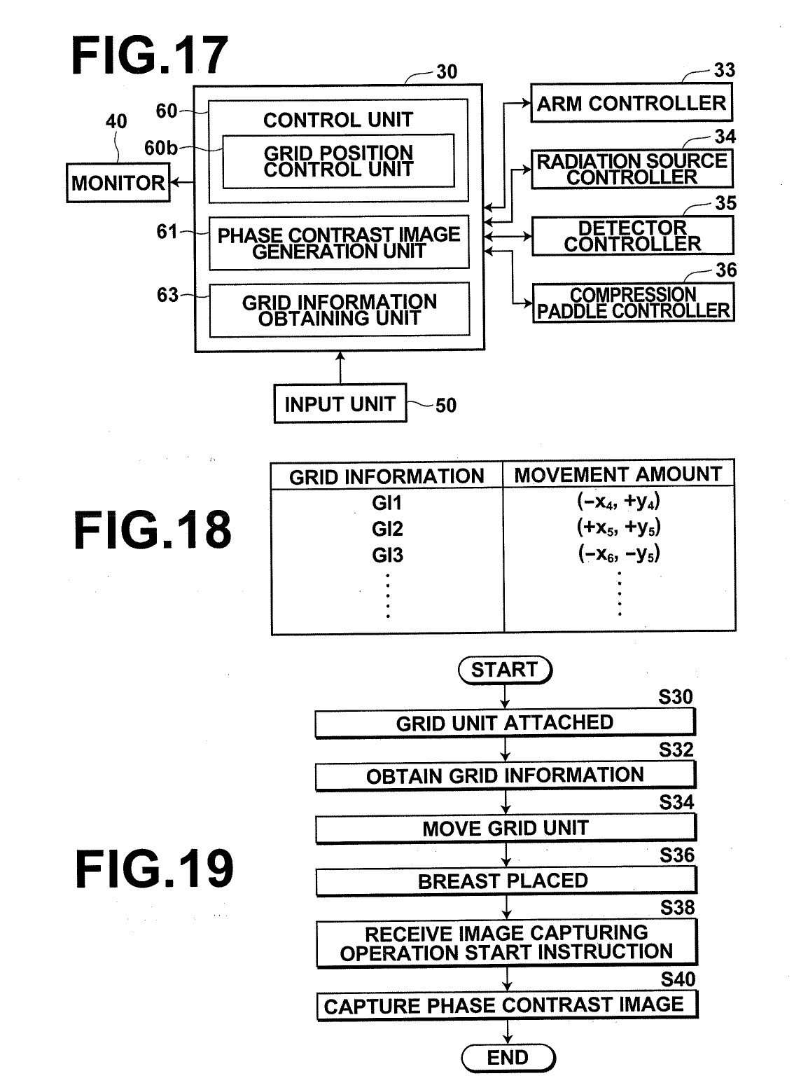

Computer 30 of the second embodiment includes grid position control unit 60b and grid information obtaining unit 63, as illustrated in FIG. 17.

Grid position control unit 60b causes grid moving mechanism 7 provided in arm 13 to move grid unit 16 in X-Y directions by outputting a control signal to grid moving mechanism 7 based on grid information obtained by grid information obtaining unit 63. More specifically, grid position control unit 60b includes therein a preset table that relates grid information to movement amounts of grid unit 16 in X-Y directions as shown in FIG. 18. Grid position control unit 60b receives grid information, refers to the table based on the received grid information to obtain a movement amount corresponding to the grid information, and outputs a control signal according to the movement amount to grid moving mechanism 7. Note that the movement amounts are those of grid unit 16 from a predetermined default position thereof.

In the present embodiment, it is assumed that the table includes movement amounts that cause radiation transmitted through first grid 2 and second grid 3 is incident on the center of radiation image detector 4 in cassette unit 17.

Grid information obtaining unit 63 may obtain grid information inputted by the radiological technologist via input unit 50. Grid information inputted by the radiological technologist differs depending on the sizes of first grid 2 and second grid 3 inside of grid unit 16 in X and Y directions. Sizes of first grid 2 and second grid 3 may include but not limited to 6 in (15.2 cm)×6 in (15.2 cm), 8 in (20.3 cm)×8 in (20.3 cm), 10 in (25.4 cm)×10 in (25.4 cm). In the case where the first and second grids have different sizes from each other, the grid information is determined based on either one of the sizes.

In the present invention, grid information is set and entered, but sizes of first grid 2 and second grid 3 in X and Y directions may be directly set and entered. Further, in the present embodiment, grid information is set and entered by the radiological technologist, but grid information may be obtained by presetting grid information in grid unit 16 and reading the grid information by grid information obtaining unit 63.

An operation of the breast image capturing and display system of the present embodiment will be described with reference to the flowchart shown FIG. 19.

First, a desired grid unit 16 is selected by the radiological technologist from various types of grid units 16 of different sizes according to the size of the breast B and imaging techniques, and selected grid unit 16 is attached to grid support 16a (S30).

Then, grid information of grid unit 16 attached to grid support 16a is entered by the radiological technologist via input unit 50, and the entered grid information is obtained by grid information obtaining unit 63 (S32).

The grid information obtained by grid information obtaining unit 63 is outputted to grid position control unit 60b, and grid position control unit 60b refers to the table shown in FIG. 18 to obtain a movement amount of grid unit 16 based on entered grid information and outputs a control signal to grid moving mechanism 7 according to the movement amount. Grid moving mechanism 7 moves grid unit 16 by moving grid support 16a according to the inputted control signal (S34). More specifically, grid unit 16 is moved such that radiation transmitted through first grid 2 and second grid 3 in grid unit 16 is incident on the center of radiation image detector 4 in cassette unit 17 as described above.

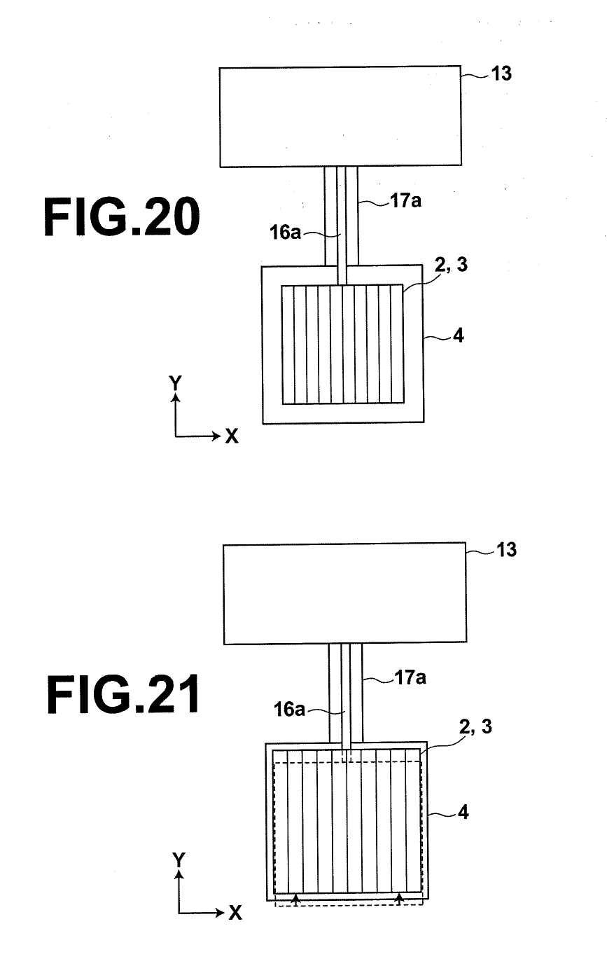

For example, in the case where grid unit 16 (first and second grids 2, 3) disposed such that first grid 2 and second grid 3 in grid unit 16 are placed at a position corresponding to the center of the detection surface of radiation image detector 4 in cassette unit 17 in the previous image capturing operation, as illustrated in FIG. 20, is replaced with relatively large grid unit 16 (first and second grids 2, 3) in the present image capturing operation, as illustrated by the dotted line in FIG. 21, first grid 2 and second grid 3 in grid unit 16 will be out of the position corresponding to the center of the detection surface of radiation image detector 4 in cassette unit 17.

Consequently, grid support 16a is shortened by grid moving mechanism 7 to move grid unit 16 such that the position of first grid 2 and second grid 3 is changed from the position indicated by the dotted line to the position indicated by the solid line, as shown in FIG. 21, thereby causing first grid 2 and second grid 3 in grid unit 16 to be placed at a position corresponding to the center of the detection surface of radiation image detector 4. This allows radiation transmitted through first grid 2 and second grid 3 in grid unit 16 without vignetting of radiation to be incident on the center of detection surface of radiation image detector 4 in cassette unit 17.

Note that radiation source 1 in radiation source unit 15 is also moved in Y direction according to the movement of grid unit 16.

Then, after the position of grid unit 16 is adjusted in the manner as described above, a phase contrast image capturing operation is initiated (S38, S40). The operation for capturing the phase contrast image is identical to that of the first embodiment described above.

In the breast image capturing and display system of the first embodiment, the cassette unit 17 is configured to be movable and in the breast image capturing and display system of the second embodiment, the grid unit 16 is configured to be movable. But an arrangement may be adopted in which both the cassette unit 17 and grid unit 16 are configured to be movable. In this case, the cassette unit 17 and grid unit 16 may be move relative to each other such that radiation transmitted through first grid 2 and second grid 3 in grid unit 16 is incident on the center of radiation image detector 4 in cassette unit 17.

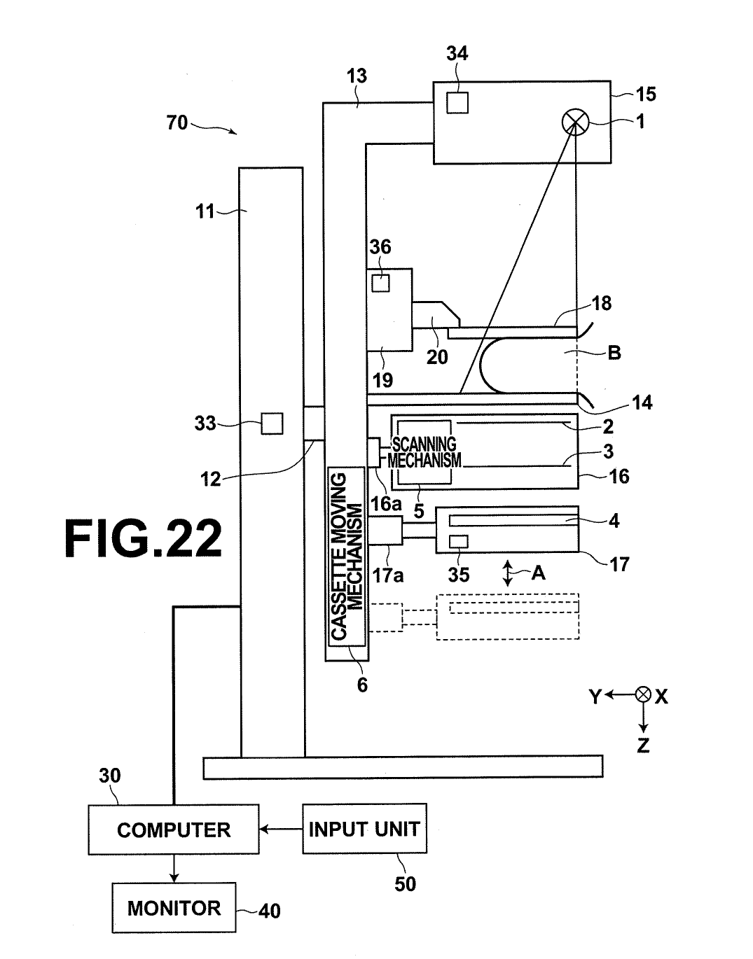

Further, in breast image capturing apparatus 10 of the breast image capturing and display system of the aforementioned embodiment, cassette unit 17 is configured to be movable within the X-Y plane. Further, as in breast image capturing apparatus 70 shown in FIG. 22, cassette support 17a may be configured to be movable also in the arrow “A” directions (directions toward and away from the breast B), thereby forming a structure that allows magnification imaging.

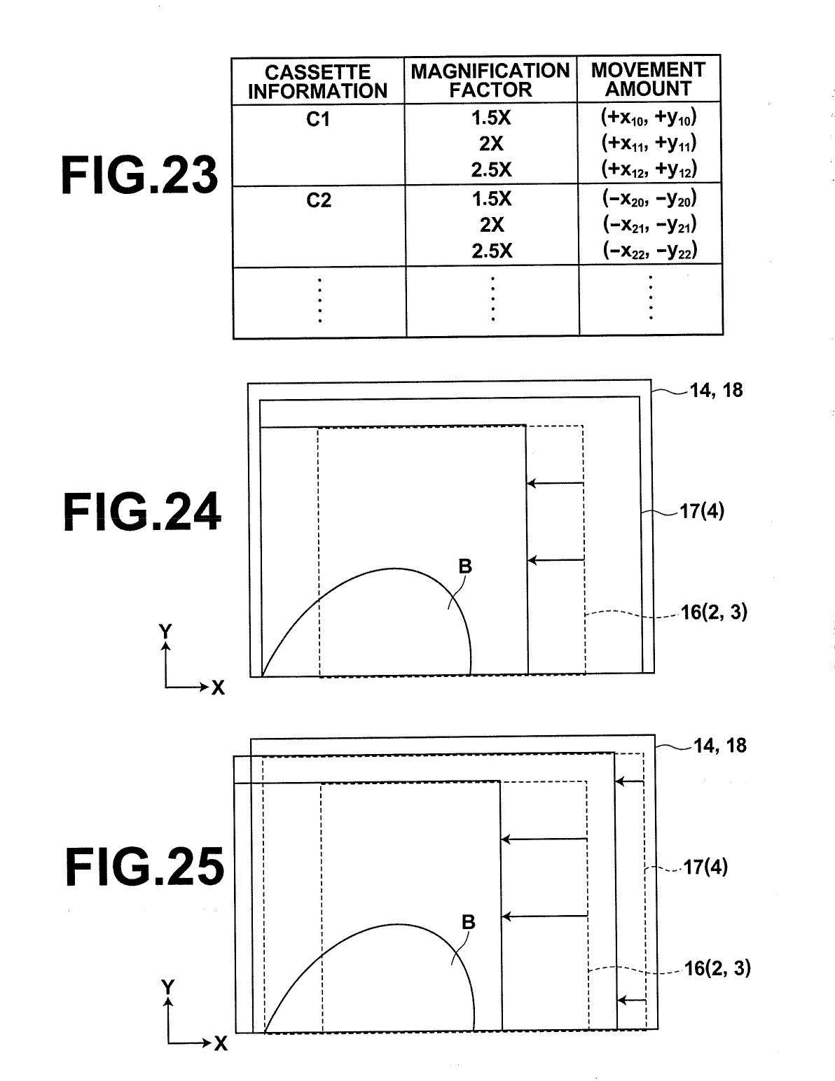

In the case where such structure for performing magnification imaging is formed, the area of radiation image detector 4 irradiated with radiation transmitted through first grid 2 and second grid 3 will differ depending on the magnification factor, it is therefore assumed that movement amounts corresponding to cassette information and magnification factors are preset in cassette position control unit 60a, as shown in FIG. 23. The term “magnification factor M” as used herein is represented as M=b/a, where “a” is the distance from the focal point of radiation source 1 to the subject and “b” is the distance from the focal point of radiation source 1 to the detection surface of radiation image detector 4. The movement amounts provided in cassette position control unit 60a are set to values so that radiation transmitted through first grid 2 and second grid 3 in grid unit 16 and magnified is confined within the detection surface of radiation image detector 4 and incident on the center of the detection surface.

Cassette position control unit 60a refers to the table shown in FIG. 23 based on the magnification factor and cassette information entered by the radiological technologist via input unit 50 to obtain a movement amount and outputs a control signal according to the movement amount to cassette moving mechanism 6.

Then, cassette moving mechanism 6 moves cassette unit 17 within the X-Y plane in response to the entered control signal according to the movement amount, as well as moving cassette unit in Z directions (arrow A directions) according to the magnification factor set and entered by the radiological technologist.

The other structures and operations are identical to those of breast image capturing apparatus 10 described above.

In the embodiment described above, grid unit 16 is moved such that radiation transmitted through first grid 2 and second grid 3 is incident on the approximate center of the detection surface of radiation image detector 4. But an arrangement may be adopted, for example, in which position information of the subject on imaging platform 14 is obtained, then grid unit 16 is moved based on the position information, and cassette unit 17 is moved based on the position of grid unit 16. Here also, radiation source 1 is moved according to the movement of grid unit 16 so that radiation emitted from radiation source 1 transmits through the center of first grid 2 and second grid 3 substantially perpendicularly.

More specifically, in breast image capturing, there may be a case in which an area from either left or right breast to the armpit is to be imaged. In such a case, the breast B is placed on the left side (or right side) of imaging platform 14 with respect to the center of imaging platform 14 or compression paddle 18, as illustrated in FIG. 24.

Thus, in order to appropriately image the area from the breast placed on one side to the armpit, grid unit 16 (first and second grids 2, 3) may be moved from the position indicated by the dotted line in FIG. 24 to the position indicated by the solid line based on placement position information of the breast B so that the breast B comes within the exposure range of radiation transmitted through first grid 2 and second grid 3.

Further, as illustrated in FIG. 25, an arrangement may be adopted in which grid unit 16 (first and second grids 2, 3) is moved from the position indicated by the dotted line in FIG. 25 to the position indicated by the solid line so that the breast B comes to the left-right center of the exposure range of the radiation transmitted through first grid 2 and second grid 3, and cassette unit 17 (radiation image detector 4) is also moved from the position indicated by the dotted line to the position indicated by the solid line in FIG. 25 so as to be aligned with the left end (or right end, although not shown) of grid unit 16 (first and second grids 2, 3).

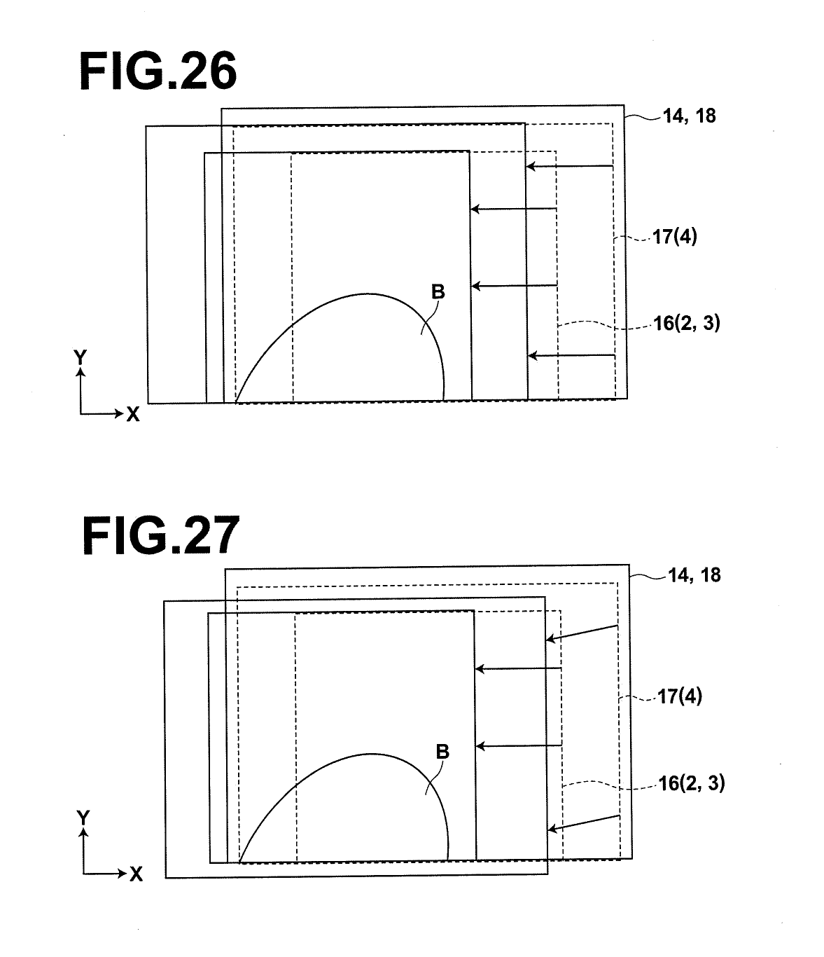

Still further, as illustrated in FIG. 26, another arrangement may be adopted in which grid unit 16 (first and second grids 2, 3) is moved from the position indicated by the dotted line in FIG. 26 to the position indicated by the solid line so that the breast B comes to the left-right center of the exposure range of the radiation transmitted through first grid 2 and second grid 3, and cassette unit 17 (radiation image detector 4) is also moved from the position indicated by the dotted line to the position indicated by the solid line in FIG. 26 so as to be placed at the left-right center of grid unit 16 (first and second grids 2, 3).

Further, as illustrated in FIG. 27, still another arrangement may be adopted in which grid unit 16 (first and second grids 2, 3) is moved from the position indicated by the dotted line in FIG. 27 to the position indicated by the solid line so that the breast B comes to the left-right center of the exposure range of the radiation transmitted through first grid 2 and second grid 3, and cassette unit 17 (radiation image detector 4) is also moved from the position indicated by the dotted line in FIG. 27 to the position indicated by the solid line so as to be placed at the center of grid unit 16 (first and second grids 2, 3) in the left-right and up-down directions.

Movement amounts of grid unit 16 and cassette unit 17 may be preset in a table or the like by relating the movement amounts to subject position information or the like. The subject position information may be entered by the radiological technologist via input unit 50 or detected automatically by providing a sensor or the like.

Further, for example, in the case where a structure that allows an image capturing of not only a breast but also other subject, such as a hand, is employed, there may be a case in which a hand is placed at the center of imaging platform 14 or a breast is placed along one side of imaging platform. Also, in such a case, subject position information may be obtained, and grid unit 16 and cassette unit 17 may be moved based on the position information.

In the case where grid unit 16 and cassette unit 17 are moved based on the subject position information as described above, grid unit 16 and cassette unit 17 are not necessarily to be removably attachable and fixed units may be used.

Further, in the case where an image capturing operation is performed by placing the subject on a side of radiation image detector 4, as in the breast image capturing operation described above, if a signal readout range of radiation image detector 4 is limited from an end of radiation image detector 4 to the place where the subject is present, an advantageous effect of timesaving control for signal reading may be obtained.

Still further, in the embodiment described above, grid moving mechanism 7 for moving grid unit 16 and cassette moving mechanism 6 for moving cassette unit 17 are provided as the mechanisms for adjusting the positions thereof. But, instead of providing such mechanisms, a jig having a shape that positions grid unit 16 into place may be formed with respect to each size of grid unit 16, and grid unit 16 of each size may be placed at the desired position by interchangeably attaching the jig to grid support 16a. The desired position refers to the same position as that after the movement by the moving mechanism in the embodiment described above.

Likewise, for cassette unit 17, instead of providing the moving mechanism, a jig having a shape that positions cassette unit 17 into place may be formed with respect to each size of cassette unit 17, and cassette unit 17 of each size may be placed at the desired position by interchangeably attaching the jig to cassette support 17a. The desired position refers to the same position as that after the movement by the moving mechanism in the embodiment described above.

In the radiation image capturing apparatus of the embodiment described above, the distance Z₂ from the first grid 2 to second grid 3 is set to the Talbot interference distance, but a configuration may be adopted in which first grid 2 projects the incident radiation without diffraction. Such configuration will result in that a projection image projected through first grid 2 may be obtained analogously at any position behind first grid 2, so that the distance Z₂ from the first grid 2 to second grid 3 may be set independently of the Talbot interference distance.

More specifically, first grid 2 and second grid 3 are formed as absorption (amplitude modulation) grids and such that radiation passed through the slit sections thereof is projected geometrically, regardless of whether or not the Talbot effect is produced. More particularly, most of the incident radiation may be straightly passed through the slit sections without being diffracted by setting the distance d″ between each member of first grid 2 and the distance d₂ between each member of second grid 3 to a value sufficiently larger than the effective wavelength of radiation emitted from radiation source 1. For example, in the case of the radiation source with a tungsten target, the effective wavelength of the radiation is about 0.4 Å at a tube voltage of 50 kV. In this case, if the distance d₁ between each member of first grid 2 and the distance d₂ between each member of second grid 3 are set to a value from 1 μm to 10 μm, most of the radiation is geometrically projected without being diffracted by the slit.

The relationship between grid pitch P₁ of first grid 2 and grid pitch P₂ of second grid 3 is identical to that of the first embodiment.

In the radiation phase contrast image capturing system configured in the manner as described above, the distance Z₂ between first grid 2 and second grid 3 may be set to a value smaller than the minimum Talbot interference distance calculated by Formula (6) given above when 1 is substituted to m′ (m′=1). That is, the distance Z₂ is set to a value that satisfies Formula (19) given below.

$${Z}_{2} < \frac{{P}_{1} {P}_{2}}{λ} \qquad ( 19 )$$

Preferably, member 22 of first grid 2 and member 32 of second grid 3 completely block (absorb) radiation in order to generate a high contrast periodic pattern image. But radiation transmitting therethrough without being absorbed may present in no small amount even if a material with high absorption property (gold, platinum, or the like) is used. Therefore, in order to improve radiation blocking capability, it is preferable that the thicknesses h₁, h₂ of members 22, 23 are made as thick as possible. Preferably, radiation blocking of members 22, 32 is not less than 90% of the incident radiation. For example, in the case where the tube voltage of radiation source 1 is 50 kV, it is preferable that the thicknesses h₁, h₂ are not less than 100 μm in terms of gold (Au).

As in the embodiment described above, however, the problem of so-called vignetting of radiation may exist, so that the thicknesses h₁, h₂ of members 22, 23 of first grid 2 and second grid 3 are limited.

According to the radiation phase contrast image capturing system configured in the manner as described above, the distance Z₂ from first grid 2 to second grid 3 may be made smaller than the Talbot interference distance, so that the image capturing system may be made thinner in comparison with the radiation image capturing system of the first embodiment that ensures a certain Talbot interference distance.

Even where such structure is employed, the pitches of first grid 2 and second grid 3 are in the range from 1 μm to 10 μm which is very small in comparison with the range from several tens to several hundred μm for a low density grid pitch for removing scattered rays in general radiation imaging. Therefore, in order not to reduce the intensity of radiation transmitted through first grid 2 and second grid 3 without vignetting, it is important to adjust the position of first grid 2 and second grid 3 such that the center of radiation transmits through the center of first and second grids substantially perpendicularly. Consequently, the advantageous effect of adjusting the position in an in-plane direction of the detection surface of radiation image detector 4 of the present embodiment by cassette moving mechanism 6 is far greater in comparison with a low density grid for removing scattered rays in general radiation imaging.

The phase contrast image described above is reconstructed by measuring a phase shift of the radiation wave-front interacting with a subject through measurement of a intensity change in a moiré pattern generated by two grids. If the intensity of the radiation is reduced when passed through the grids, the signal to noise ratio (S/N) of the moiré pattern image is degraded, which may cause a calculation error when reconstructing the phase contrast image from a fractional intensity change of the moiré image and a significant degradation in the contrast and resolution of the phase contrast image. In the case of, an ordinary X-ray still or motion imaging with anti-scattering grid to suppress scattered radiation, in which the image is not reconstructed by calculation from a fractional intensity change, unevenness in one image due to positional displacement of the grid relative to the radiation source or radiation image detector is acceptable for diagnosis in many case. When compared to these, the impact of the vignetting of radiation by the grids on the phase contrast image is far greater.

In the embodiment described above, second grid 3 is translated by scanning mechanism 5 in grid unit 16 and the image capturing operation is performed a plurality of times to obtain image signals of a plurality of fringe images for generating a phase contrast image. But there is a method for obtaining image signals of a plurality of fringe images by one image capturing operation without translating the second grid.

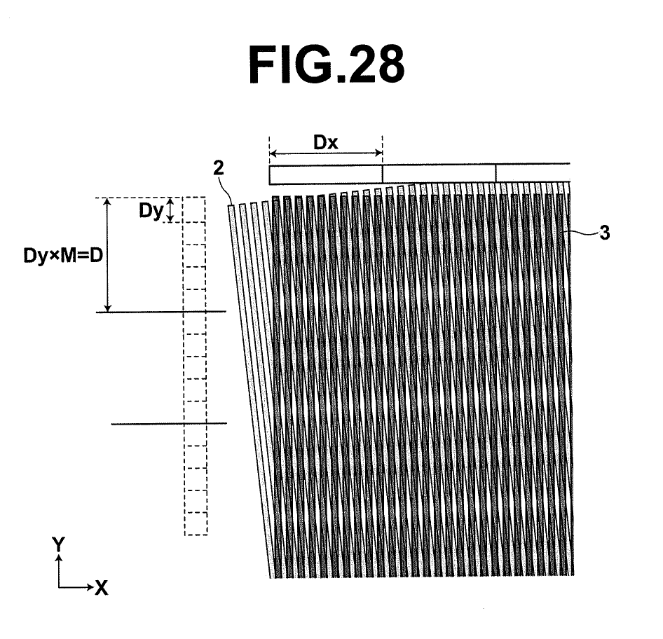

More specifically, as illustrated in FIG. 28, first grid 2 and second grid 3 are disposed such that the extension direction of the self image G1 of first grid 2 is inclined relative to the extension direction of second grid 3. Then, with respect to first grid 2 and second grid 3 disposed in the manner as described above, a main pixel size Dx in the main scanning direction (X direction in FIG. 28) of each pixel of an image signal detected by radiation image detector 4 and sub-pixel size Dy in the sub-scanning direction fall in the relationship shown in FIG. 28.

In the case where a so-called optical readout radiation image detector having a multiple linear electrodes and an image signal is read by scanning the detector with a linear readout light source extended in a direction orthogonal to the direction in which the linear electrodes are extended is used as radiation image detector 4, the main pixel size Dx is determined by the arrangement pitch of the liner electrodes of the radiation image detector. Here, the sub-pixel size Dy is determined by the width of the linear readout light directed to the radiation image detector in a direction in which the linear electrodes extend. In the meat time, in the case where a so-called TFT readout radiation image detector or a CMOS radiation image detector is used as radiation image detector 4, the main pixel size Dx is determined by the arrangement pitch of pixel circuits in the arrangement direction of data electrodes through which an image signal is read out and the sub-pixel size Dy is determined by the arrangement pitch of the pixel circuits in the arrangement direction of gate electrodes that output a gate voltage.

When the number of fringe images for generating a phase contrast image is taken as M, first grid 2 is inclined with respect to second grid 3 such that M sub-pixel sizes Dy correspond to one image resolution D in the sub-scanning direction of phase contrast image.

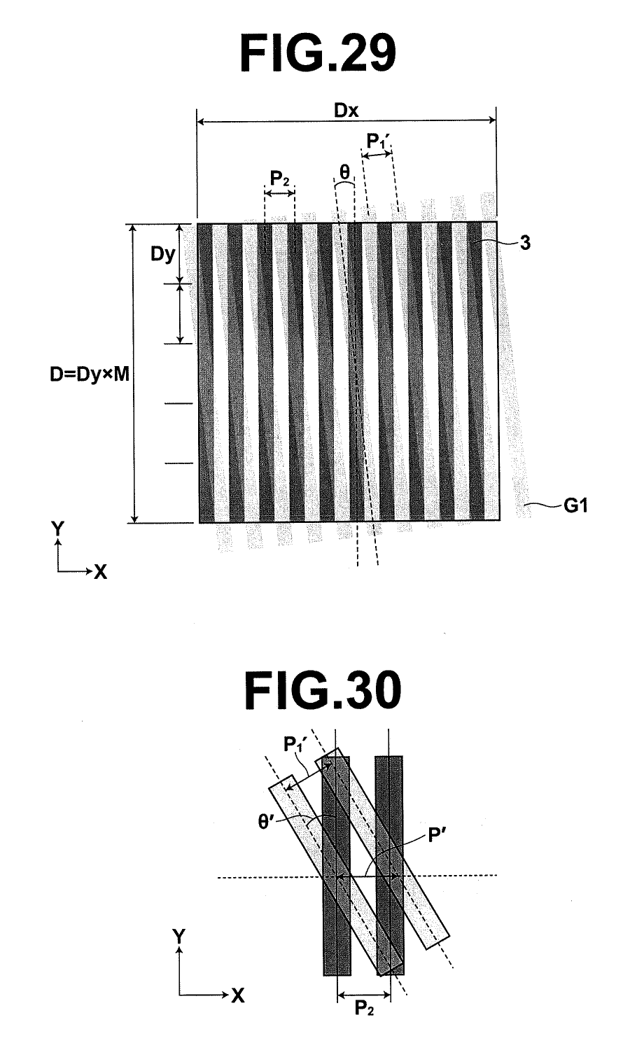

More specifically, when the pitch of second grid 3 and the pitch of the self image G1 of first grid 2 formed by first grid 2 at the position of second grid 3 is taken as p₁′, the rotation angle of the self image G1 of first grid 2 relative to second grid is taken as θ, and image resolution of the phase contrast image in the sub-scanning direction is taken as D(=Dy×M), if the rotation angle θ is set to a value that satisfies Formula (20) given below, the phase of the self image G1 of the first grid 2 deviates from that of second grid 3 by an amount of n period(s) over the length of the image resolution D in the sub-scanning direction, as illustrated in FIG. 29. Note that FIG. 29 illustrates a case in which M=5

$$θ = arc tan \{ n \times \frac{{P}_{1}^{′}}{D} \} \qquad ( 20 )$$

and n=1.

Thus, image signals of intensity modulation of the self image G1 of first grid 2 for n periods divided by M may be detected by each pixel Dx×Dy in which image resolution D of the phase contrast image in the sub-scanning direction is divided by M. In the example show in FIG. 29, the phase of the self image G1 of first grid 2 deviates from that of second grid 3 by one period over the length of the image resolution D in the sub-scanning direction because n=1. To put it more plainly, the range of the self image G1 of first grid 2 for one period that passes through second grid 3 varies over the length of the image resolution D in the sub-scanning direction.

As M=5, image signals of intensity modulation of the self image G1 of first grid 2 for one period divided by 5 may be detected by each Dx×Dy pixel, that is, image signals of 5 different fringe images may be detected by each Dx×Dy pixel.

If, for example, it is assumed that Dx=50 μm, Dy=10 μm, and M=5, the image resolution Dx of the phase contrast image in the main scanning direction and image resolution D=Dy×M in the sub-scanning direction will be same, but they are not necessary to be same and any main/sub ratio may be used.

Although it is assumed that M=5 here, the value of M may be other than 5 as long as it is not less than 3. Further, it is assumed that n=1 here, but the value of n may be other than 1 as long as it is an integer except for 0. That is, if the value of n is a negative integer, the rotation is reversed with respect to the example described above. Further, the value of n may be set to an integer other than ±1 to obtain intensity modulation for n periods. Note that, however, if the value of n is a multiple of M, the phase of the self image G1 of first grid 2 and the phase of second grid 3 become the same in a set of M pixels Dy in the sub-scanning direction, whereby M different fringe images can not be obtained. Therefore, values of multiples of M are excluded for the value of n.

The adjustment of the rotation angle θ of the self image G1 of first grid 2 relative to second grid 3 may be made by, for example, fixing the relative rotation angle between radiation image detector 4 and second grid 3 first and then rotating first grid.

For example, if it is assumed that p₁′=5 μm, D=50 μm, and n=1 in Formula (19) above, the rotation angle θ is set to be 5.7°. The actual rotation angle θ of the self image G1 of first grid 2 relative to second grid 3 may be detected, for example, from the pitch of the moiré pattern generated by the self image G1 of first grid 2 and second grid 3.

More specifically, as illustrated in FIG. 30, if the actual rotation angle is taken as θ′ and the apparent pitch of the self image G1 in X direction caused by the rotation is taken as P′, the pitch Pm of the moiré pattern that can be observed may be expressed as follows.

1/Pm=|1/P′−1/P₁′|

Thus, the actual rotation angle θ′ may be obtained by substituting P′=P₁′/cos θ′ to the formula given above. The pitch Pm of the moiré pattern may be obtained based on the image signal detected by radiation image detector 4.

Then, a comparison may be made between the actual rotation angle θ′ and the rotation angle θ to be set which is derived from Formula (20), and the rotation angle of first grid 2 may be adjusted automatically or manually by the difference.

In the radiation phase contrast image capturing system configured in the manner as described above, the whole of image signals for one frame read from radiation image detector 4 are stored in phase contrast image generation unit 61 and image signals of 5 different fringe images are obtained based on the stored image signals.

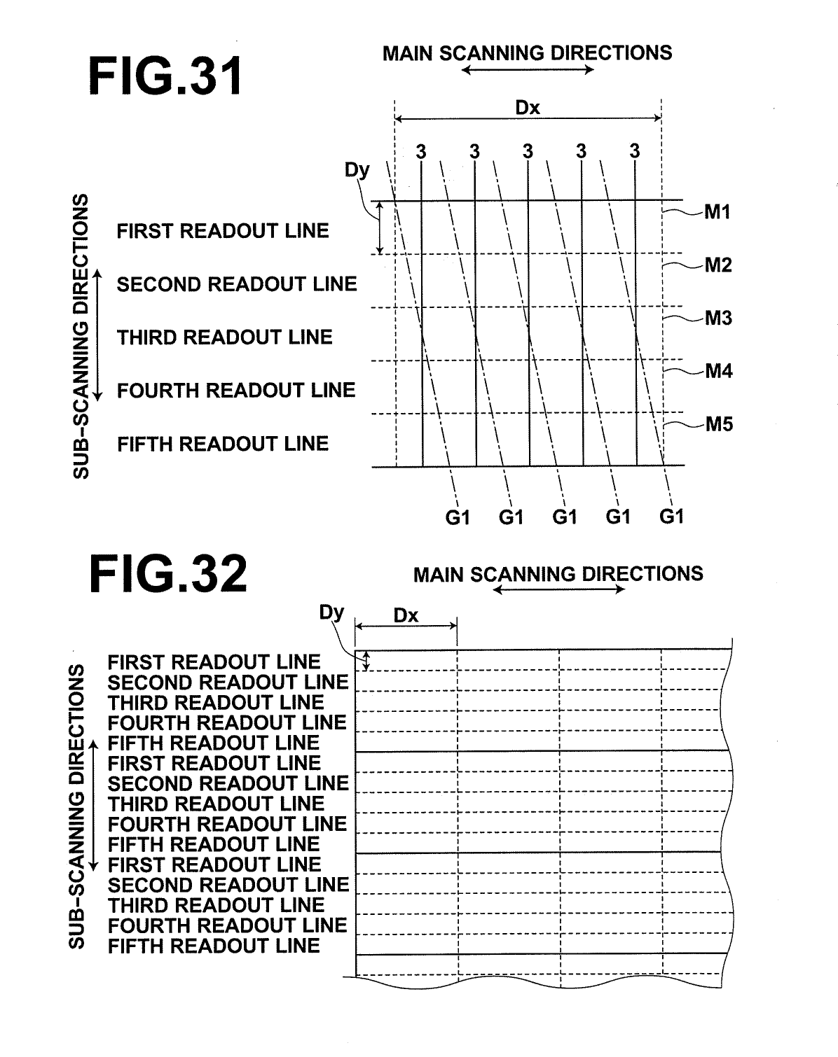

More specifically, as illustrated in FIG. 29, if image resolution D of the phase contrast image in the sub-scanning direction is divided by 5 and the self image G1 of first grid 2 is inclined relative to second grid 3 such that image signals of intensity modulation of the self image G1 of first grid 2 for one period divided by 5 are obtained, an image signal read from a first readout line is obtained as a first fringe image signal M1, an image signal read from a second readout line is obtained as a second fringe image signal M2, an image signal read from a third readout line is obtained as a third fringe image signal M3, an image signal read from a fourth readout line is obtained as a fourth fringe image signal M4, and an image signal read from a fifth readout line is obtained as a fifth fringe image signal M5, as illustrated in FIG. 31. Note that the each of the lines 1 to 5 shown in FIG. 31 corresponds to the sub-pixel size Dy.

Although FIG. 31 illustrates only a readout range of Dx×(Dy×5), but 1 to 5 fringe images are obtained from other readout ranges in the same manner as described above. That is, as illustrated in FIG. 32, one frame of one fringe image signal is obtained when image signals of a pixel row group constituted by pixel rows (readout lines) of every four pixel intervals in the sub-scanning direction are obtained. More specifically, one frame of first fringe image signal is obtained when image signals of the pixel row group of first readout lines are obtained, one frame of second fringe image signal is obtained when image signals of the pixel row group of second readout lines are obtained, one frame of third fringe image signal is obtained when image signals of the pixel row group of third readout lines are obtained, one frame of fourth fringe image signal is obtained when image signals of the pixel row group of fourth readout lines are obtained, and one frame of fifth fringe image signal is obtained when image signals of the pixel row group of fifth readout lines are obtained.

Then, based on the first to fifth fringe image signals, a phase contrast image is generated in phase contrast image generation unit 61.

In the description above, a plurality of fringe image signals is obtained from one image captured with first grid 2 and second grid 3 being disposed such that the extension direction of the self image G1 of first grid 2 and extension direction of second grid 3 are inclined relative to each other, as illustrated in FIG. 28, by obtaining image signals of pixel row groups different from each other, and a phase contrast image is generated using the plurality of fringe image signals. But, instead of generating a plurality of fringe image signals based on one image captured in the manner as described above, a Fourier transform may be performed on the image to generate a phase contrast image. Thus, such method may also be used.

More specifically, a Fourier transform may be performed on one image captured with first grid 2 and second grid 3 being disposed such that the extension direction of first grid 2 and extension direction of second grid 3 are inclined relative to each other to separate absorption information from phase information included in the image due to the subject B.

Then, in the frequency space, only the phase information due to the subject B is extracted and moved to the center (origin) of the frequency space. Then, an inverse Fourier transform is performed on the extracted phase information and an arctangent function of resultant imaginary part divided by real part (arctan (imaginary part/real part)) is calculated with respect to each pixel, whereby the refraction angle φ in Formula (18) may be obtained. Then, the differential amount of phase shift distribution in Formula (14), that is, differential phase image may be obtained.

Although, in the method for generating a phase contrast image using the Fourier transform, one image captured with first grid 2 and second grid 3 being disposed such that the extension direction of the self image G1 of first grid 2 and extension direction of second grid 3 are inclined relative to each other is used, but instead of using such image, a moiré pattern may be generated by superimposing the self image G1 of first grid 2 and second grid 3 on top of each other and at least one image (fringe image) in which the moiré pattern is detected may be used.

Further, in the radiation phase contrast image capturing system of the embodiment described above, two grids, first grid 2 and second grid 3, are used but second grid 3 may be omitted by providing the function of second grid 3 in the radiation image detector. Hereinafter, a structure of a radiation image detector having the function of second grid 3 will be described.

The radiation image detector having the function of second grid is a detector that detects a self image G1 of first grid 2 formed by first grid 2 when radiation is passed through first grid 2, and stores a charge signal according to the self image G1 in a charge storage layer divided into a grid pattern, to be described later, thereby intensity-modulating the self image G1 to generate a fringe image and outputting the fringe image as an image signal.

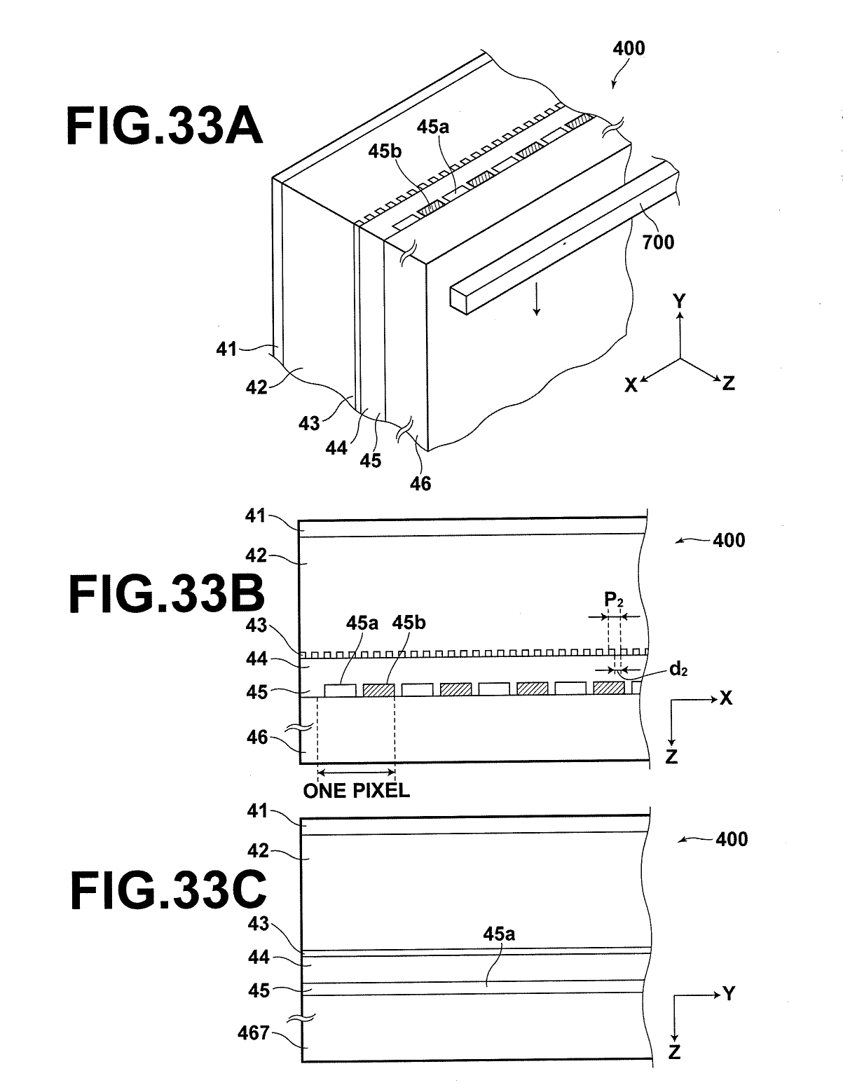

FIG. 33A is a perspective view of radiation image detector 400 having the function of second grid, FIG. 33B is an X-Z cross-sectional view of the radiation image detector shown in FIG. 33A, and FIG. 33C is a Y-Z cross-sectional view of the radiation image detector shown in FIG. 33A.

As illustrated in FIGS. 33A to 33C, radiation image detector 400 includes the following stacked on top of each other in the order listed below: first electrode layer 41 that transmits radiation; recording photoconductive layer 42 that generates electric charges by receiving radiation transmitted through first electrode layer 41; charge storage layer 43 that acts as an insulator against a charge of either polarity and as a conductor for a charge of the other polarity; readout photoconductive layer 44 that generates electric charges by receiving readout light; and second electrode layer 45. Each of the layers is stacked on glass substrate 46 from second electrode layer 45.

First electrode layer 41 may be made of any material as long as it transmits radiation. For example, a NESA film (SnO₂), ITO (Indium Tin Oxide), IZO (Indium Zinc Oxide), IDIXO (Indemitsu Indium X-metal Oxide, Idemitsu Kosan Co., Ltd.), which is an amorphous state transparent oxide film, or the like with a thickness in the range from around 50 to around 200 nm may be used. Alternatively, Al or Au with a thickness of 100 nm may also be used.

Recording photoconductive layer 42 may be made of any material as long as it generates electric charges by receiving radiation. Here, a material which includes a-Se as the major component is used, since a-Se has superior properties including high quantum efficiency for radiation and high dark resistance. Preferably, the thickness of the recording photoconductive layer 42 is in the range from 10 μm to 1500 μm. For mammography application, the thickness is preferable to be in the range from 150 μm to 250 μm, while for general imaging application, the thickness is preferable to be in the range from 500 μm to 1200 μm.

Charge storage layer 43 may be any film as long as it is insulative to the polarity of electric charges desired to be stored, and may be made of acrylic organic resins, polymers, such as polyimide, BCB, PVA, acrylic, polyethylene, polycarbonate, and polyetherimide, sulfides, such as As₂S₃, Sb₂S₃, ZnS, and the like, in addition to oxides and fluorides. More preferably, charge storage layer 43 is made of a material which is insulative to the polarity of electric charges desired to be stored and conductive to the other polarity and has a triple-digit difference or more in the produce of mobility x operating life between the polarities of electric charges.

Preferable compounds include As₂Se₃, As₂Se₃ doped with 500 ppm to 2000 ppm of Cl, Br, or I, As₂(SexTe1−x)₃ (0.5<x<1) prepared by substituting Se in As₂Se₃ with Te up to about 50%, As₂Se₃ in which Se is substituted with S up to about 50%, AsₓSe_{y} (x+y=100, 34≦x≧46) prepared by changing the concentration of As in As₂Se₃ about ±15%, and an amorphous Se—Te system with 5 to 30 wt % of Te.

Preferably, a material having a dielectric constant of one half to twice of the dielectric constant of recording photoconductive layer 42 and readout photoconductive layer 44 is used for charge storage layer 43 in order not to bend electric lines of force formed between first electrode layer 41 and second electrode layer 45.

As illustrated in FIGS. 33A to 33C, charge storage layer 43 is divided linearly so as to be parallel with the extension direction of linear transparent electrode 45a and opaque liner electrode 45b of second electrode layer 45.

Charge storage layer 43 is divided with a finer pitch than that of linear transparent electrode 45a or linear opaque electrode 45b, and the condition of the arrangement pitch P₂ and distance d₂ is the same as that of second grid 3 in the embodiment described above.

Further, charge storage layer 43 is formed with a thickness of not greater than 2 μm in the stacking direction (Z direction).

Charge storage layer 43 may be formed by a resistance heating deposition process using one of the materials described above and a metal mask which is a metal plate with well-aligned apertures or a mask made of a fiber. Alternatively, charge storage layer 43 may be formed by photolithography.

Readout photoconductive layer 44 maybe made of any material as long as it shows electrical conductivity by receiving readout light. For example, photoconductive materials that consist mainly of at least one of the materials selected from the group consisting of a-Se, Se—Te, Se—As—Te, nonmetal phthalocyanine, metal phthalocyanine, MgPc (Magnesium phthalocyanie), VoPc (phase II of Vanadyl phthalocyanine), CuPc (Copper phthalocyanine), and the like are preferably used. Preferably, the thickness of the readout photoconductive layer 44 is 5 to 20 μm.

Second electrode layer 45 includes a plurality of transparent linear electrodes 45a and a plurality of opaque linear electrodes 45b. Transparent linear electrodes 45a and opaque linear electrodes 45b extend linearly and continuously from one end to the other end of the image forming area of radiation image detector 400. As illustrated in FIGS. 33A and 33B, transparent linear electrodes 45a and opaque linear electrodes 45b are disposed alternately in parallel at a predetermined distance.

Transparent linear electrode 45a is made of an electrically conductive material that transmits the readout light. For example, ITO, IZO, or IDIXO may be used as in the first electrode layer 41. The thickness of transparent electrode 45a is 100 to 200 nm.

Opaque linear electrode 45b is made of an electrically conductive material that blocks the readout light. For example, a combination of one of the transparent conductive material and a color filter may be used. The thickness of the transparent conductive material is about 100 to 200 nm.

In radiation image detector 400, an image signal is read out using a pair of adjacent linear transparent electrode 45a and linear opaque electrode 45b, to be described later in detail. That is, as illustrated in FIG. 33B, an image signal of one pixel is read out by a pair of linear transparent electrode 45a and linear opaque electrode 45b. For example, linear transparent electrodes 45a and linear opaque electrodes may be arranged such that the size of one pixel becomes about 50 μm.

As illustrated in FIG. 33A, linear readout light source 700 extending in a direction (X direction) orthogonal to the extension direction of linear transparent electrodes 45a and linear opaque electrodes 45b is provided in cassette unit 17. Linear readout light source 700 includes a light source of LEDs (Light Emitting Diodes) or LDs (Laser Diodes) and a given optical system, and configured to emit linear readout light with a width of about 10 μm onto radiation image detector 400 in the extension directions (Y directions) of linear transparent electrodes 45a and linear opaque electrodes 45b. Linear readout light source 700 is configured to be moved by a give moving mechanism (not shown) in Y directions and radiation image detector 400 is scanned with the linear readout light emitted from the linear readout light source 700 by the movement, whereby image signals are read out.

The distance condition between first grid 2 and radiation image detector 400 to function as a Talbot interferometer is the same as that between first grid 2 and second grid 3 since radiation image detector 400 functions as second grid 3.

An operation of radiation image detector 400 configured in the manner as described above will now be described.

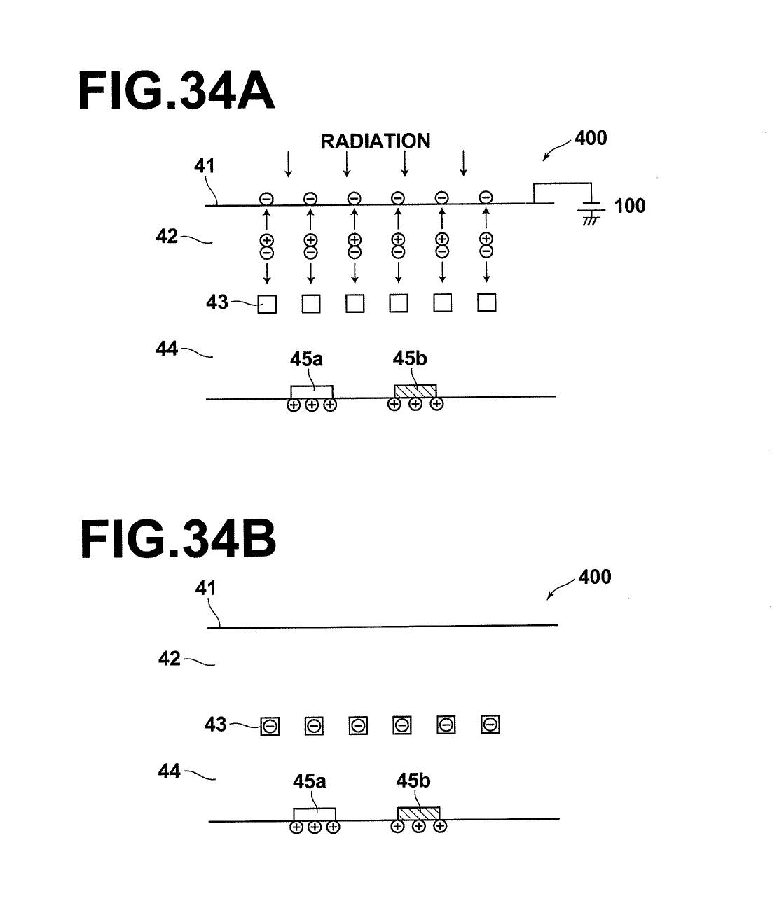

First, as shown in FIG. 34A, radiation representing a self image of first grid 2 generated by Talbot effect is directed to radiation image detector 400 from the side of first electrode layer 41 with a negative voltage being applied to first electrode layer 41 of radiation image detector 400 from high voltage source 100.

The radiation incident on radiation image detector 400 transmits through first electrode layer 41 and reaches recording photoconductive layer 42. Then, electron-hole pairs are generated by the radiation. The positive electric charges of the electron-hole pairs are coupled with the negative electric charges charged on first electrode layer 41 and disappear, while the negative charges of the electron-hole pairs are stored in charge storage layer 43 as latent image charges (FIG. 34B).

As charge storage layer 43 is linearly divided with the aforementioned arrangement pitch, only some of the electric charges generated according to the self image G1 of first grid 2 in recording photoconductive layer 42 directly under which charge storage layers 43 are present may be trapped by and stored in charge storage layers 43 while the other electric charges pass through a gap between charge storage layers 43 (non-charge storage area) and flow out to linear transparent electrodes 45a and linear opaque electrodes 45b.

Storage of only some of the electric charges generated in recording photoconductive layer 42 directly under which charge storage layers 43 are present may result in that the self image G1 of first grid 2 is superimposed with the linear pattern of charge storage layers 43 and intensity-modulated, whereby an image signal of fringe image reflecting distortion of a wave-front of the self image G1 of first grid 2 due to the subject B is stored in charge storage layers 43. That is, charge storage layers 43 may provide a function equivalent to that of second grid 3.

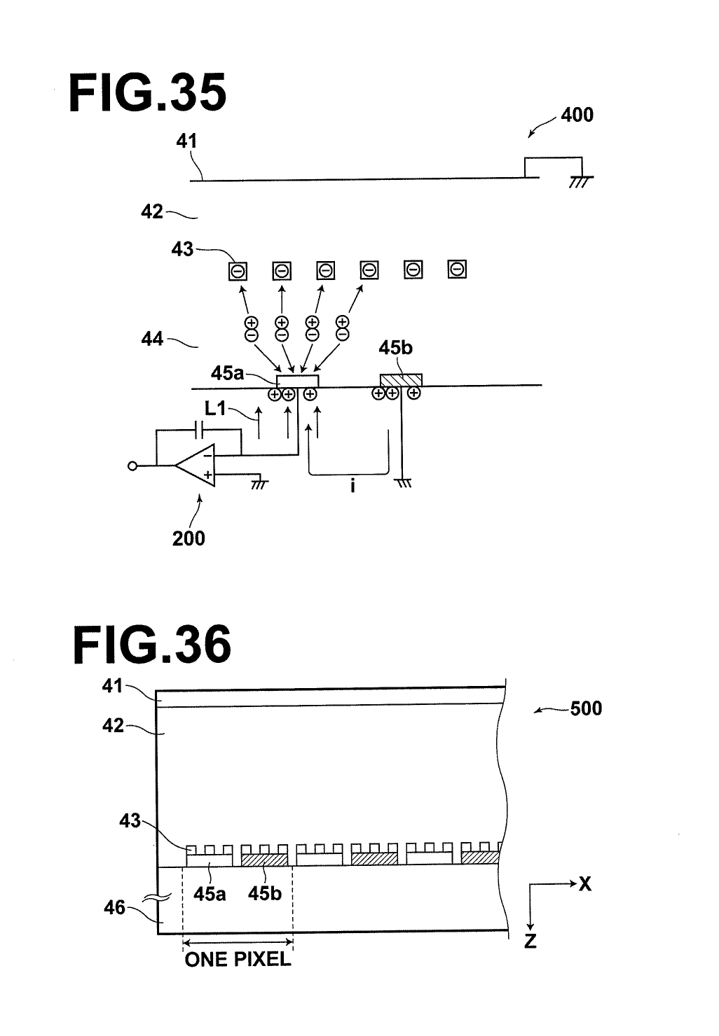

Next, as illustrated in FIG. 35, with the first electrode layer 41 being grounded, linear readout light L1 emitted from linear readout light source 700 is directed to radiation image detector 400 from the side of second electrode layer 45. The readout light L1 transmits through linear transparent electrodes 45a and reaches readout photoconductive layer 44. Then, positive electric charges generated in readout photoconductive layer 44 by the readout light L1 are coupled with the latent image charges stored in charge storage layers 43, while negative electric charges are coupled with positive electric charges charged on each of linear opaque electrodes 45b through a charge amplifier 200 connected to each of linear transparent electrodes 45a.

Then, the coupling of the negative charges generated in readout photoconductive layer 44 with the positive charges charged on each of linear opaque electrodes 45b causes an electric current to flow through each of charge amplifiers 200 and the electric currents are integrated and detected as an image signal.

Then, linear readout light source 700 is moved in the sub-scanning direction (Y direction) to scan radiation image detector 400 with the linear readout light L1, whereby image signals are sequentially detected with respect to each readout line illuminated by the linear readout light L1 in the manner as described above and the detected image signals with respect to each readout line are sequentially inputted to phase contrast image generation unit 61 and stored therein.

Thereafter, the entire surface of radiation image detector 400 is scanned with the readout light L1 and image signals of one frame are stored in phase contrast image generation unit 61.

Then, as second grid 3 is translated with respect to first grid 2 in the radiation phase contrast image capturing system of the embodiment described above, radiation image detector 400 having the function of second grid 3 is translated to obtain a plurality of fringe images.

Then, based on five fringe image signals, a phase contrast image is generated in phase contrast image generation unit 61

Although radiation image detector 400 having the function of second grid 3 includes three layers of recording photoconductive layer 42, charge storage layers 43, and readout photoconductive layer 44 between two electrode layers, but the layer structure is not necessarily limited to this and, for example, linear charge storage layers 43 may be provided so as to directly contact linear transparent electrodes 45a and linear opaque electrodes 45b of second electrode layer 45 without providing readout photoconductive layer 44, and recording photoconductive layer 42 may be provided on charge storage layers 43, as illustrated in FIG. 36. Note that recording photoconductive layer 42 also functions as a readout photoconductive layer.

Radiation image detector 500 has a structure in which charge storage layers 43 are provided directly on second electrode layer 45, thereby allowing linear charge storage layers 43 to be formed easily. That is, linear charge storage layers 43 may be formed by deposition. In the deposition process, a metal mask or the like is used for selectively forming a linear pattern. The structure in which linear charge storage layers 43 are provided on readout photoconductive layer 44 requires handling in the air between the deposition process of readout photoconductive layer 44 and deposition process of recording photoconductive layer 42 for setting the metal mask after readout photoconductive layer 44 is deposited. This may cause degradation in readout photoconductive layer 44 or mixing of foreign object between the two photoconductive layers, resulting in quality degradation. The structure that does not provide readout photoconductive layer 44 may reduce handling time in the air and the concern of quality degradation described above may be reduced.

As for the materials of recording photoconductive layer 42 and charge storage layers 43, identical materials to those used in radiation image detector 400 may be used. The structure of charge storage layers 43 is also identical to that of the radiation image detector described above.

An Operation of radiation image detector 500 for recording and reading of a radiation image will now be described.

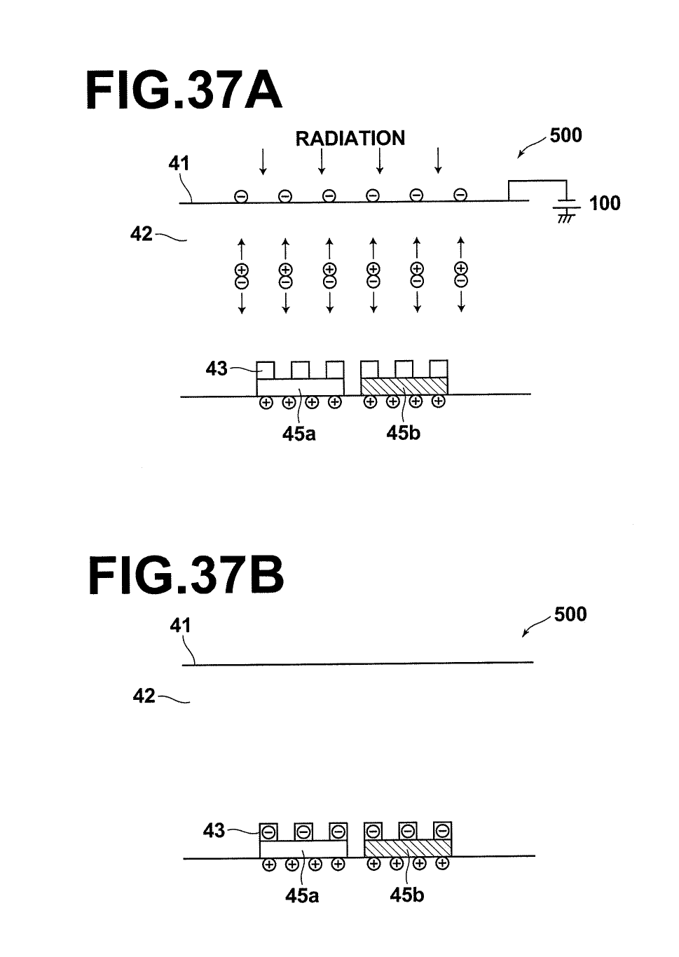

First, as shown in FIG. 37A, radiation representing a self image G1 of first grid 2 is directed to radiation image detector 500 from the side of first electrode layer 41 with a negative voltage being applied to first electrode layer 41 of radiation image detector 500 from high voltage source 100.

The radiation incident on radiation image detector 500 transmits through first electrode layer 41 and reaches recording photoconductive layer 42. Then, electron-hole pairs are generated by the radiation. The positive electric charges of the electron-hole pairs are coupled with the negative electric charges charged on first electrode layer 41 and disappear, while the negative charges of the electron-hole pairs are stored in charge storage layer 43 as latent image charges (FIG. 37B). As linear charge storage layers 43 contacting second electrode layer 45 is an insulating film, electric charges reached charge storage layers 43 are trapped and unable to move onto second electrode layer 45, whereby electric charges are accumulated thereat.

Here, as in radiation image detector 400 described above, storage of only some of the electric charges generated in recording photoconductive layer 42 directly under which charge storage layers 43 are present may result in that the self image G1 of first grid 2 is superimposed with the linear pattern of charge storage layers 43 and intensity-modulated, whereby an image signal of fringe image reflecting distortion of a wave-front of the self image of first grid 2 due to the subject B is stored in charge storage layers 43.

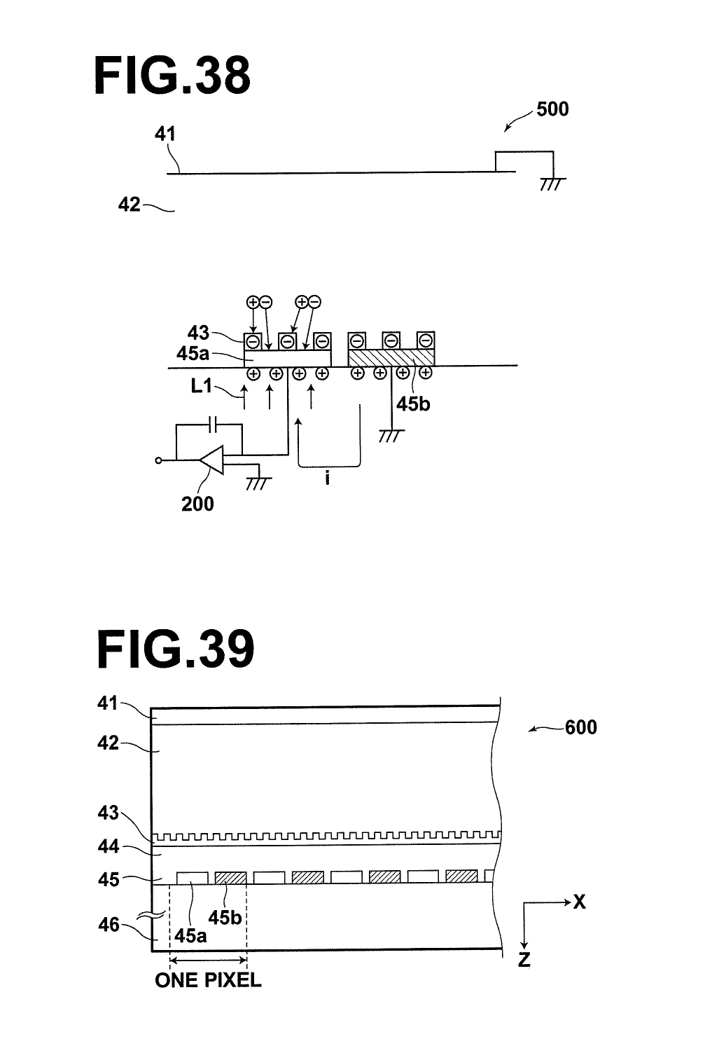

Next, as illustrated in FIG. 38, with the first electrode layer 41 being grounded, linear readout light L1 emitted from linear readout light source 700 is directed to radiation image detector 500 from the side of second electrode layer 45. The readout light L transmits through linear transparent electrodes 45a and reaches recording photoconductive layer 42 adjacent to charge storage layers 43. Then, positive electric charges generated by the readout light L1 are attracted to charge storage layers 43 and re-coupled, while negative electric charges are attracted to linear transparent electrodes 45a and coupled with positive electric charges charged on each of linear transparent electrode 45a and positive electric charges charged on each of linear opaque electrodes 45b through a charge amplifier 200 connected to each of linear transparent electrodes 45a. This causes electric currents to flow through each of charge amplifiers 200 and the electric currents are integrated and detected as an image signal.

In radiation image detectors 400 and 500 described above, charge storage layers 43 are formed as completely separate linear lines, but grid-like charge storage layers 43 may also be formed, for example, by forming a linear pattern on a plate as in radiation image detector 600 shown in FIG. 39.

Further, as in the modification of the embodiment described above in which the self image G1 of first grid 2 is inclined relative to second grid 3 in order to obtain a plurality of fringe images by one image capturing operation, the self image G1 of first grid 2 may be inclined relative to radiation image detector 400 or 500.

Note that radiation image detectors 400 and 500 according to the modifications described above may not be used in breast image capturing apparatus 70 that may perform magnification imaging.

In the embodiments described above, the description has been made of a case in which the radiation image capturing apparatus of the present invention is applied to a breast image capturing and display system. But the radiation image capturing apparatus of the present invention may also be applied to a radiation image capturing system that perform image capturing operation with a subject in the upright position, a radiation image capturing system that perform image capturing operation with a subject in the lateral position, a radiation image capturing system capable of performing image capturing operation with a subject in the upright position or in the lateral position, a radiation image capturing system that performs long length imaging, and the like.

Further, the present invention may also be applied to a radiation phase contrast CT system for obtaining a three-dimensional image, a stereoscopic imaging system for obtaining a stereoscopically viewable image, a tomosynthesis imaging system for obtaining a tomographic image, and the like.

In the embodiment described above, an image which has been difficult to be visualized can be obtained by obtaining a phase contrast image. As the conventional X-ray image diagnostics is based on absorption images, cross-referencing between absorption image and phase contrast image, if possible, is helpful for radiological image reading. For example, it is effective to compensate for a portion that can not be represented by an absorption image with information of a phase contrast image by superimposing the absorption image and phase contrast image on top of each other through appropriate processing, such as weighting, gradation processing, frequency processing, or the like.

But, separate imaging for an absorption image from that of a phase contrast image will result in difficulty in satisfactory superimposition of the images due to the motion of the subject between imaging of the phase contrast image and imaging of the absorption image, as well as increased burden on the subject due to increased number of image capturing operations. Further, small angle scattering images have recently been drawing attention other than the phase contrast image and absorption image. The small angle scattering image may represent tissue characterization arising from a microstructure inside of a tissue of the subject, and hence it is expected as a new representation method for image diagnosis in the fields of cancer, circulatory disease, and the like.

As such, an absorption image generation unit for generating an absorption image or a small angle scattering image generation unit for generating a small angle scattering image from a plurality of cassette compensated fringe images obtained for generating a phase contrast image may further be provided in computer 30.

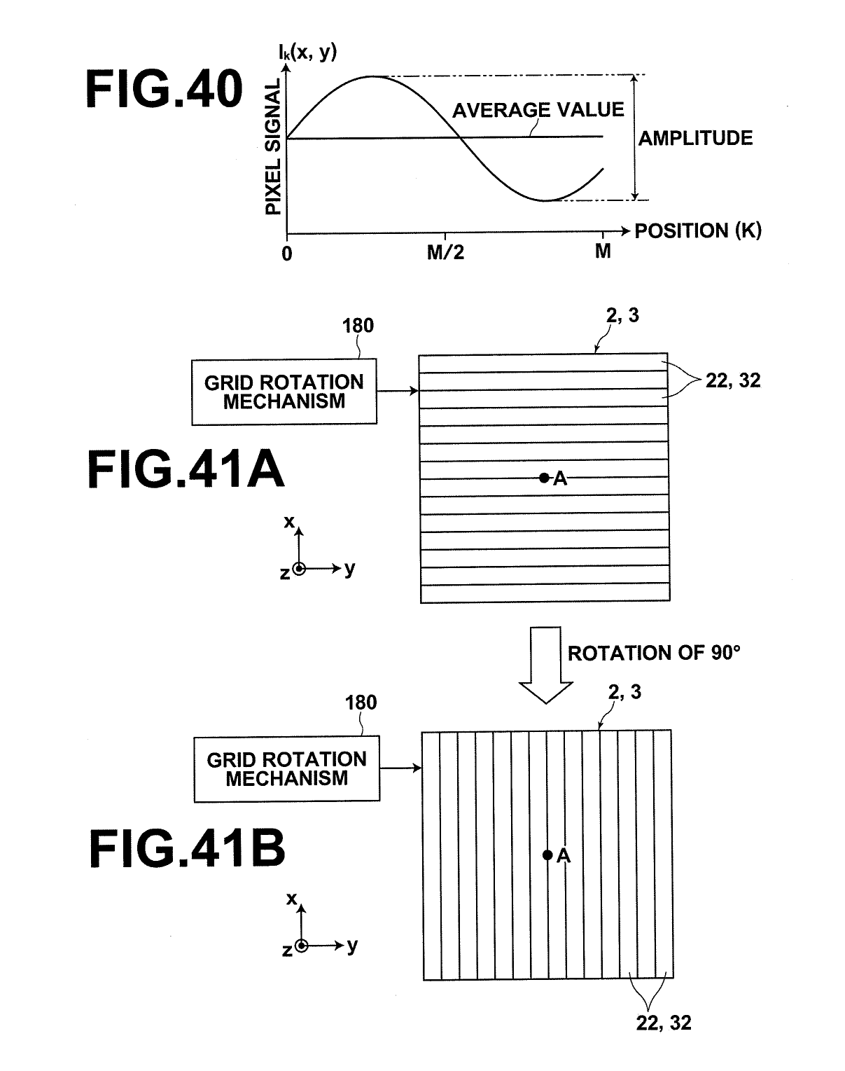

The absorption image generation unit generates an absorption image by averaging pixel signals Ik (x, y) obtained from each pixel with respect to k to obtain an average value, as illustrated in FIG. 40, and forming an image. The calculation of the average value may be performed by simply averaging the pixel signals Ik(x, y), but if the value of M is small, a larger error may result. If such is the case, pixel signals Ik (x, y) may be fitted with a sine wave and the average value of the sine wave may be obtained. Further, a rectangular wave or a triangular wave may also be used other than the sine wave.

The generation of an absorption image is not limited to the average value, and an added-up value, if it corresponds to the average value, obtained by adding the pixel signals Ik(x, y) with respect to k or the like may be used.

The small angle scattering image generation unit generates a small angle scattering image by calculating amplitude values of pixel signals Ik(x, y) obtained from each pixel and forming an image. The calculation of the amplitude value may be performed by obtaining a difference between maximum and minimum values of pixel signals Ik (x, y), but if the value of M is small, a larger error may result. If such is the case, pixel signals Ik (x, y) may be fitted with a sine wave and the amplitude value of the sine wave may be obtained. Further, a variance or a standard deviation may be used as the amount corresponding to the dispersion centered on the average value in the small angle scattering image generation other than the amplitude value.

Further, the phase contrast image is based on a refraction component of X-ray in the arrangement direction (X direction) of members 22, 32 of first and second grids 2, 3 and a refraction component in the extension direction of members 22, 32 is not reflected in the image. That is, a region contour along a direction intersecting with X direction (Y direction if intersecting at right angle) is visualized as the phase contrast image based on the refraction component in X direction and a region contour along X direction without intersecting with X direction is not visualized as the phase contrast image. That is, a region of a subject H which is not visualized may exist depending on the shape or orientation thereof. For example, if the direction of the weight bearing plane of a joint cartilage of a knee or the like is aligned with Y direction of XY directions, which are in-plane directions of the grids, a region contour adjacent to the weight bearing plane (YZ plane) substantially along Y direction is visualized satisfactorily, but a cartilage surrounding tissue (tendon or ligament) extending substantially along X direction may be insufficiently visualized. It may be possible to perform an image capturing operation again for the insufficiently visualized region by moving the subject H, but this might increase the burden for both the subject H and radiological technologist as well as posing a problem that it is difficult to ensure the position reproducibility for the image obtained by the second image capturing operation.

Consequently, as another example shown in FIG. 41, it is also advantageous to provide rotation mechanism 180 in grid unit 16 for rotating first and second grids 2, 3 centered on an imaginary line (optical axis A of X-ray) perpendicular to the center of the grid surfaces of first and second grids 2, 3 by a given angle from a first orientation shown in A of FIG. 41 to a second orientation shown in B of FIG. 41, thereby generating a phase contrast image at each of the first and second orientations.

This may eliminate the problem of position reproducibility. A of FIG. 41 shows the first orientation of first and second grids 2, 3 in which the extension direction of members 32 of second grid 3 corresponds to Y direction, while B of FIG. 41 shows the second orientation of first and second grids 2, 3 in which first and second grids 2, 3 are rotated by 90 degrees from the first orientation shown in A of FIG. 41 and the extension direction of members 32 of second grid 3 corresponds to X direction. But, first and second grids 2, 3 may be arbitrarily rotated if the inclination relationship between first grid 2 and second grid 3 is maintained. Further, an arrangement may be adopted in which the rotating operation is performed two or more times to orient first and second grids 2, 3 to third and fourth orientations in addition to the first and second orientations, and a phase contrast image is generated at each of the orientations.

Further, instead of rotating first and second grids 2, 3 which are one-dimensional grid, first and second grids 2, 3 may be formed as two-dimensional grids in which members 22, 32 are extended two-dimensional directions respectively.

This may minimize the influence of body motion and equipment vibration between image capturing operations as phase contrast images with respect to the first and second directions may be obtained by one image capturing operation, whereby better position reproducibility between the phase contrast images with respect to the first and second directions may be obtained in comparison with the case in which one-dimensional grids are rotated. Further, the rotation mechanism is not required, thereby resulting in a simplified system and reduced cost.

What is claimed is:

1. A radiation image capturing apparatus, comprising:
a first grid provided with grid structures disposed at intervals and forms a first periodic pattern image by passing radiation emitted from a radiation source;
a second grid provided with grid structures disposed at intervals and forms a second periodic pattern image by receiving the first periodic pattern image;
a radiation image detector that detects the second periodic pattern image formed by the second grid; and
a detector positioning mechanism that adjusts a position of the radiation image detector in an in-plane direction of a detection plane of the detector such that radiation transmitted through the first and second grids falls within the radiation image detector.

2. The radiation image capturing apparatus of claim 1, wherein the radiation image detector is configured to be removably attachable.

3. The radiation image capturing apparatus of claim 2, wherein:
the apparatus comprises a detector information obtaining unit that obtains size information of the radiation image detector; and
the detector positioning mechanism is a mechanism that adjusts the position of the radiation image detector based on the information obtained by the detector information obtaining unit.

4. The radiation image capturing apparatus of claim 1, wherein the first and second grids are configured to be removably attachable.

5. The radiation image capturing apparatus of claim 4, wherein the apparatus further comprises:
a grid information obtaining unit that obtains size information of at least one of the first and second grids; and
a grid positioning mechanism that adjusts positions of the first and second grids based on the information obtained by the grid information obtaining unit.

6. The radiation image capturing apparatus of claim 5, wherein the grid positioning mechanism is a mechanism that adjusts the positions of the first and second grids such that a radiation center of the radiation transmits through the centers of the first and second grids substantially perpendicularly.

7. The radiation image capturing apparatus of claim 1, wherein the detector positioning mechanism is a mechanism that adjusts the position of the radiation image detector such that a radiation range of the radiation transmitted through the first and second grids on the radiation image detector falls in the center of the detector.

8. The radiation image capturing apparatus of claim 1, wherein:
the apparatus comprises a magnification factor obtaining unit that receives and obtains input of a magnification factor for magnification imaging and a magnification imaging moving mechanism that moves the radiation image detector in directions toward and away from a subject; and
the detector positioning mechanism is a mechanism that adjusts the position of the radiation image detector based on the magnification factor obtained by the magnification factor obtaining unit.

9. The radiation image capturing apparatus of claim 1, wherein the detector positioning mechanism is a mechanism that moves the radiation image detector according to a position of a subject on an imaging platform.

10. The radiation image capturing apparatus of claim 1, wherein the detector positioning mechanism is a mechanism which includes a detector moving mechanism for moving the radiation image detector.

11. The radiation image capturing apparatus of claim 1, wherein the detector positioning mechanism is a mechanism which includes a detector positioning member formed in a shape that positions the radiation image detector into place.

12. The radiation image capturing apparatus of claim 5, wherein the grid positioning mechanism is a mechanism which includes a grid moving mechanism for moving the first and second grids.

13. The radiation image capturing apparatus of claim 5, wherein the grid positioning mechanism is a mechanism which includes a grid positioning member formed in a shape that positions the first and second grids into place.

14. The radiation image capturing apparatus of claim 1, wherein the apparatus comprises:
a scanning mechanism that moves at least either one of the first and second grids in a direction orthogonal to an extension direction of the either one of the grids; and
an image generation unit that generates an image using radiation image signals representing a plurality of second periodic pattern images detected by the radiation image detector at each position of the either one of the grids along with the movement by the scanning mechanism.

15. The radiation image capturing apparatus of claim 1, wherein:
the first and second grids are disposed such that an extension direction of the first periodic pattern of the first grid is inclined relative to an extension direction of the second grid; and
the apparatus includes image generation unit that generates an image using a radiation image signal detected by the radiation image detector through exposure of a subject to the radiation.

16. The radiation image capturing apparatus of claim 15, wherein the image generation unit is a unit that obtains radiation image signals read out from different pixel row groups as radiation image signals of different fringe images based on the radiation image signal detected by the radiation image detector, and generates an image based on the obtained radiation image signals of a plurality of fringe images.

17. The radiation image capturing apparatus of claim 1, wherein the apparatus comprises an image generation unit that performs a Fourier transform on a radiation image signal detected by the radiation image detector through exposure of a subject to the radiation and generates a phase contrast image based on a result of the Fourier transform.

18. A radiation image obtaining method for obtaining a radiation image using a radiation image capturing apparatus which comprises: a first grid provided with grid structures disposed at intervals and forms a first periodic pattern image by passing radiation emitted from a radiation source; a second grid provided with grid structures disposed at intervals and forms a second periodic pattern image by receiving the first periodic pattern image; and a radiation image detector that detects the second periodic pattern image formed by the second grid, the method comprising the step of:
adjusting a position of the radiation image detector by a detector positioning mechanism in an in-plane direction of a detection plane of the detector such that radiation transmitted through the first and second grids falls within the radiation image detector.
